(19) United States
(12) Patent Application Publication
(10) Pub. No.: US 2012/0246297 A1
(43) Pub. Date: Sep. 27, 2012

(54) AGENT BASED MONITORING FOR SAAS IT SERVICE MANAGEMENT

(76) Inventors: Vijaya Shanker, Bangalore (IN); Vasudev Nayak, Bangalore (IN)

(21) Appl. No.: 13/072,572

(22) Filed: Mar. 25, 2011

(51) Int. Cl. G06F 15/173

(52) U.S. Cl. 709/224

(57) ABSTRACT

An apparatus for agent based monitoring software-as-a-service information technology service management. Proxy clients are installed on network equipment devices belonging to a customer. Each proxy client includes discovery module(s) to discover network equipment devices on at least one private network of the customer, a discovery reporting module to transmit information identifying the devices discovered by the discovery modules to a server using web services, and monitoring module that monitors network equipment device(s) according to monitoring definition(s) configured by the customer to collect information of those network equipment devices, receives monitored information from monitoring agents installed on different network equipment devices, and transmits the information collected and the received monitored information to the server using web services. Each of the monitoring definitions identifies which of the network equipment devices to monitor and defines parameter(s) of the monitoring.

### FIELD

Embodiments of the invention relate to the field of information technology (IT) service management; and more specifically, to agent based monitoring for SaaS (software-as-a-service) IT service management.

### BACKGROUND

In certain prior art systems, IT service monitoring and reporting for devices (e.g., servers, user devices, etc.) is performed on the Internet where the customer network is behind a firewall. All of the discovery and monitoring may be done from a centralized server over the Internet, however this requires a large amount of traffic to be moved through the LAN (Local Area Network) and WAN (Wide Area Network). The firewall of the customer network also causes difficulty in monitoring and reporting for these devices.

One approach for monitoring and reporting in these types of systems is to establish a VPN (virtual private network) link between the monitoring server and the customer private network. However, VPN connectivity between the server and the customer private network itself needs to be monitored and if the VPN connection is lost for any reasons, the devices cannot be monitored. An agent can also be installed on certain devices to push reporting data across the Internet. Device scan also be monitored through the exposure of certain monitoring protocols (e.g., SNMP (Simple Network Management Protocol) and/or WMI (Windows Management Instrumentation)) over the Internet. However, exposing these protocols or providing Internet access to the devices brings an Internet security risk.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary agent based SaaS IT service management implementation according to one embodiment;

FIG. 2 is a flow diagram illustrating exemplary operations performed in the agent based SaaS IT service management system according to one embodiment;

FIG. 3 is a flow diagram illustrating exemplary operations for establishing monitoring in the agent based SaaS IT service management system according to one embodiment;

FIG. 4 is a more detailed view of the proxy client and its interaction with the server and the devices in the private network according to one embodiment;

FIG. 5 is a flow diagram that illustrates exemplary operations performed by an agent (a system agent or end user agent) for monitoring information according to one embodiment;

FIG. 6 is a flow diagram that illustrates exemplary operations performed by a proxy client for monitoring and transmitting monitored information to the SaaS server according to one embodiment;

FIG. 7 is a flow diagram illustrating exemplary operations performed on the SaaS server when receiving monitored information from a proxy client according to one embodiment;

FIG. 8 illustrates an exemplary proxy client configuration tool according to one embodiment;

FIG. 9 illustrates the proxy client configuration tool of FIG. 8 with the discovery tab selected according to one embodiment;

FIG. 10 illustrates an exemplary server discovery configuration screen according to one embodiment;

FIG. 11 illustrates an exemplary server discovery result screen according to one embodiment;

FIG. 12 illustrates an exemplary XML file containing server discovery information according to one embodiment;

FIG. 13 illustrates a network discovery configuration screen according to one embodiment;

FIG. 14 illustrates an exemplary XML file containing network discovery information according to one embodiment;

FIG. 15 illustrates an exemplary XML file containing network discovery information according to one embodiment;

FIG. 16 illustrates an exemplary end user device discovery screen according to one embodiment;

FIG. 17 illustrates one embodiment of an integrated discovery screen that shows devices that have discovered by multiple proxy clients according to one embodiment;

FIG. 18 illustrates an exemplary monitoring configuration screen used to configure a monitoring definition for a device according to one embodiment;

FIG. 19 illustrates an exemplary monitoring configuration scheduling screen that allows a customer to define the monitoring interval for monitoring tasks according to one embodiment;

FIG. 20 illustrates an exemplary XML file representing a monitoring definition according to one embodiment;

FIG. 21 illustrates a group policy management screen that illustrates an organizational unit for devices to receive an agent has been configured according to one embodiment;

FIG. 22 illustrates the group policy management screen of FIG. 21 that indicates that the deployment source, which is a network address (URL) to the agent and configuration file, is assigned to the members of the OU according to one embodiment;

FIG. 23 illustrates an exemplary XML file containing monitored information according to one embodiment;

FIG. 24 illustrates an exemplary monitored information screen 2410 that shows devices, their status, and other monitoring information in a graphical way according to one embodiment;

FIG. 25 illustrates the monitored information details screen 2510 of a device that is being monitored according to one embodiment;

FIG. 26 illustrates an exemplary CPU utilization details screen that is displayed responsive to the customer selecting a CPU utilization link according to one embodiment;

FIG. 27 illustrates an exemplary memory utilization details screen that is displayed response to the customer selecting a memory utilization link according to one embodiment; and

FIG. 28 illustrates application usage data collected by an agent according to one embodiment.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

A method and apparatus for agent based monitoring for SaaS (software as a service) IT (information technology) service management is described. In one embodiment, a SaaS IT Service Management server (hereinafter “server”) manages aspects related to IT management for multiple customers and their devices. A customer may have a private network or subnet. In one embodiment, a customer installs one or more proxy clients on one or more of their network devices to perform discovery of their network devices and monitoring (agentless monitoring) of their network devices. For example, a customer installs a proxy client onto one of its servers and uses that proxy client to discover devices in the network (e.g., in the same subnet). The proxy client then sends information that identifies the discovered devices to the server (hereinafter referred to as “discovery information”). In one embodiment, the discovery information is sent through an encrypted connection and uses web services (e.g., using HTTP or HTTPs). In one embodiment, the discovery information is sent in an XML (Extensible Markup Language) file, which may also be encrypted. The server then stores information about the discovered devices for the customer. In this way, the server is able to maintain information about the discovered devices in the customer's private network without requiring a VPN (virtual private network) link between the server and the network, without exposing SNMP (Simple Network Management Protocol) and/or WMI (Windows Management Instrumentation) protocols, without requiring that each device in the network be connected or accessible by the server, and without additional configuration on any firewall in the customer's private network(s).

The customers may login to the server and view the devices that were discovered by the proxy client(s) in their networks. In addition to discovering devices in the network, the agent based SaaS IT service management system also includes monitoring capability to monitor at least some of the discovered network devices. In one embodiment, monitoring includes collecting information from at least some of the discovered devices (hereinafter referred to as “monitored information”). For example, the monitored information may include CPU utilization, memory utilization, application usage, WMI data, SNMP data, availability monitoring, services monitoring, hardware health monitoring, etc.

In one embodiment, customers establish a monitoring definition that identifies the device(s) to monitor, defines a schedule of when the monitoring is to occur, defines the type of monitoring (e.g., agentless or agent based), and defines the protocols and parameters of monitoring. The monitoring definition may be established using the server and/or at a proxy client. For example, the customer may use the discovery information to determine and select which one(s) of their devices are to be monitored. The monitoring definition may be established using the server and pushed to the proxy client(s) and/or configured by the customer at the proxy client. In another embodiment, the proxy client(s) periodically query the server for the monitoring definition(s), which may include any updated monitoring definition(s). In one embodiment, the monitoring definition is represented in an XML file when transmitted to the proxy client, which may be encrypted.

The monitoring may be agentless (e.g., SNMP, WMI, SSH, Telnet, availability monitoring only) and/or agent based (e.g., end user agent or system agent). In agentless monitoring, the proxy client collects information (e.g., using SNMP, WMI, SSH, Telnet) from certain devices in the customer's network. In agent based monitoring, a monitoring agent (end user agent or system agent) is installed on a device of the network (typically apart from the device in which the proxy client is installed) and collects information from that device and sends the monitored information to the proxy client (e.g., in an XML file) The proxy client transmits the data collected from agentless monitoring (if any) and the data collected from the agent(s) (if any) to the server (e.g., in an XML file).

Monitoring is periodic and the monitoring interval can differ between agent based monitoring and agentless monitoring. For example, typically the smallest time period between two monitoring cycles using agentless monitoring such as SNMP or WMI cannot be less than thirty seconds. As a result, monitoring real time values (e.g., total CPU utilization, total memory utilization, CPU utilization per process, memory utilization per process, etc.) may not be possible using agentless monitoring such as SNMP or WMI. The time period between two monitoring cycles using agent based monitoring (e.g., with use of an end user agent or system agent) can be less than thirty seconds (e.g., each second). As a result, real time values (e.g., total CPU utilization, total memory utilization, CPU utilization per process, memory utilization per process, etc.) may be monitored using agent based monitoring.

Agent based monitoring can collect different information than agentless monitoring. For example, the monitoring agents (end user agent and system agent) allow for more particularized information to be monitored than using agentless monitoring alone. For example, end user agents allow for application usage data (e.g., word processing usage, Internet browser usage, etc.) to be collected. End user agents are typically installed on end user systems (e.g., laptops, desktops, workstations). System agents are typically installed on servers, directory servers, or other non-end user systems.

As another example, agentless monitoring, such as monitoring using SNMP or WMI, typically cannot collect the actual usage date of software installed on a device. Agent based monitoring (e.g., using an end user agent or system agent) allows monitoring of the actual usage date of software installed on a device. This information may be used by the customer to identify users who are not making use of the software licenses installed in their system and make adjustments accordingly (e.g., remove software licenses from those devices, move the software to a different device, etc.).

Agent based monitoring includes installing an agent (end user agent or system agent) on a device that collects the data according to a monitoring definition at a configured monitoring interval. After collecting the data, the agent prepares the monitored information for transmission to the proxy client. In one embodiment, preparing the monitored information includes creating and populating an XML file that represents the monitored information, which may be encrypted. The network address (e.g., URL, IP address) of the proxy client is configured on the agent to allow the agent to transmit the monitored information to the proxy client. The transmission uses web services (e.g., HTTP, HTTPs). Thus the proxy client is enabled with web services to allow the agents to communicate with the proxy client using generic web services. If the connection between an agent and the proxy client fails or the monitored information otherwise cannot be successfully transmitted to the proxy client, in one embodiment the agent stores the monitored information and attempts to transmit the monitored information when the connection is restored.

In one embodiment, the agents are configured for frequency of data collection and transmission to the proxy client using a time based job scheduler on the device (e.g., Cron, task scheduler). The proxy client may be coupled with multiple agents on multiple devices. In one embodiment, at least some of the agents can be configured to collect their data using at different monitoring intervals and/or transmit the collected data to the proxy client at different times. This may decrease the load at the proxy client at any given time.

The proxy client collects data using agentless monitoring according to the monitoring definition at the configured monitoring interval. After collecting the data, the proxy client prepares the monitored information for transmission to the server (including the monitored information received from any agent and the monitored information collected by the proxy client using agentless monitoring techniques). In one embodiment, preparing the monitored information includes creating and populating an XML file that represents the monitored information, which may be encrypted. The network address (e.g., URL, IP address) of the server is configured on the proxy client to allow the proxy client to transmit the monitored information to the server. The monitored information is transmitted to the server using web services (e.g., HTTP, HTTPs). In this way, the server is able to maintain monitored information on the discovered devices in the customer's private network without requiring a VPN link between the server and the network, without exposing SNMP and/or WMI protocols over the Internet, without requiring that each device in the network be connected or accessible by the server, and without additional configuration on any firewall in the customer's private network.

If the connection between the proxy client and the server fails or the monitored information otherwise cannot be successfully transmitted to the server, in one embodiment the proxy client stores the monitored information and will transmit (or retransmit) the monitored information to the server when the connection is restored. In addition, if the server cannot be reached, in one embodiment the monitoring continues using the latest monitoring definition(s). As a result, when the server is again reachable, the monitored information will be as accurate as possible. In one embodiment, the proxy client stores the monitored information until confirmation that the server has received it (e.g., an acknowledgement message) or until a more recent version of the monitored information has been collected.

In one embodiment, each time the proxy client communicates with the server, it includes authentication information (e.g., a username and/or password). The server authenticates the proxy client based on the authentication information. If the proxy client is not authenticated, then the data (e.g., the monitoring data) is ignored. If the proxy client is authenticated, then in one embodiment, the server performs an authorization procedure based on the data being transmitted to ensure that the authenticated proxy client is authorized to send the data that is being transmitted. For example, the server determines whether the data belongs to the customer that is associated with the proxy client sending the data. By way of a specific example, in the case of monitoring data being transmitted, the server compares the IP addresses of the devices represented by that monitoring data with the IP addresses of the devices that have been discovered for the customer that is associated with the authentication information transmitted by the proxy client.

Customers can install multiple proxy clients throughout their customer network. In one embodiment, each of the proxy clients is configured with different authentication credentials (e.g., a different username and/or password) to assist the server in distinguishing between different proxy clients of the same customer. In this way, the customers can distribute the load on the proxy servers (in particular the monitoring load) so as to not create a bottleneck in the customer network.

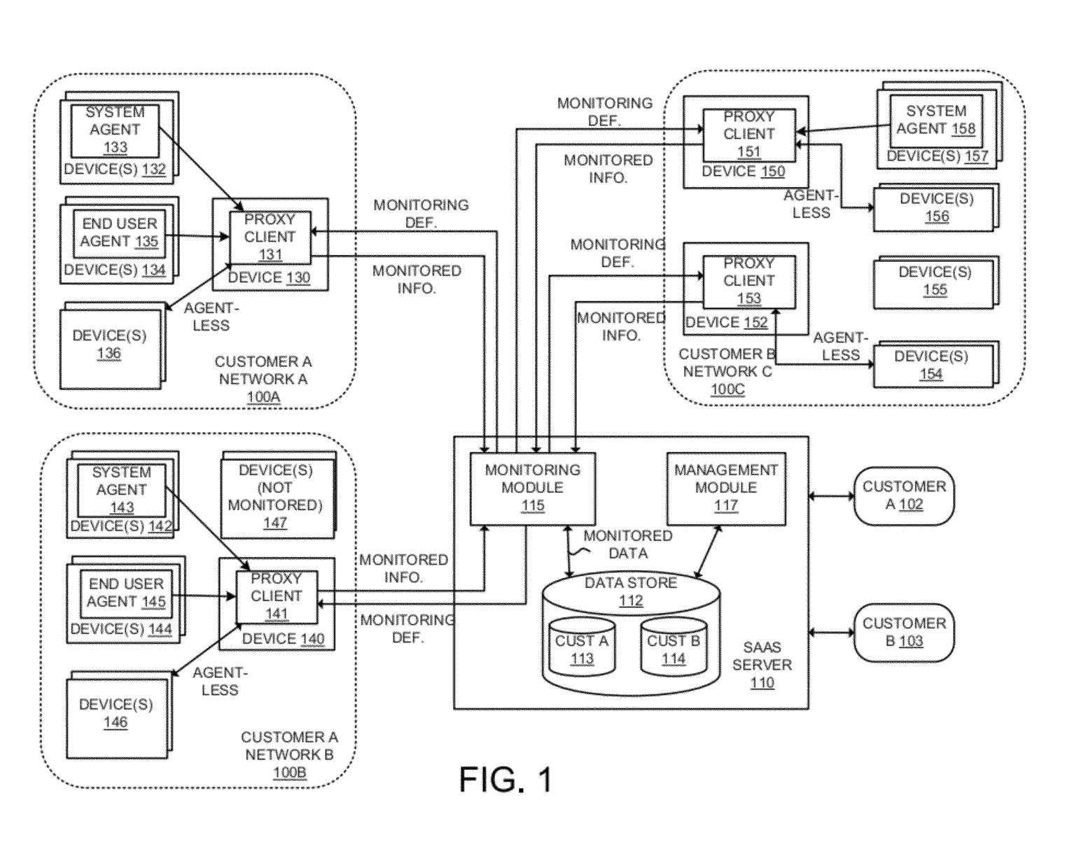

FIG. 1 illustrates an exemplary agent based SaaS IT service management implementation according to one embodiment. The agent based SaaS IT service management system illustrated in FIG. 1 includes the SaaS server 110 that provides agent based SaaS IT management service for the customer A 102 and the customer B 103. In one embodiment, the SaaS server 110 is accessible to the customer A 102 and the customer B 103 through the Internet (e.g., using a standard browser, a dedicated application, etc.).

As illustrated in FIG. 1, the network A 100A and the network B 100B belong to the customer A 102. In one embodiment, the network A 100A and the network B 100B are different networks (e.g., separated by different geographic locations), while in other embodiments the network A 100A and the network B 100B are subnets of the same network. The customer B 103 has the network C 100C. Each of the networks includes multiple network equipment devices (referred herein as “devices”). The devices can include, for example, servers, directory servers, routers, switches, hubs, access points, printers, fax machines, copy machines, modems, workstations, laptops, netbooks, palm tops, tablets, mobile phones, smartphones, multimedia phones, Voice Over Internet Protocol (VOIP) phones, user equipment, terminals, portable media players, set-top boxes, or other devices that can connect to the private customer network and/or connect to a public network (e.g., the Internet).

The network A 100A includes the device 130, the device(s) 132, the device(s) 134, and the device(s) 136. The proxy client 131 is installed on the device 130 and performs discovery and monitoring service for the other devices in the network A 100A, which will be described in greater detail later herein. As illustrated in FIG. 1, the proxy client 131 has discovered the device(s) 132, device(s) 134, and the device(s) 136.

The device(s) 132 each include a system agent 133 and each of the device(s) 134 includes an end user agent 135. As will be described in greater detail later herein, the system agent and the end user agent are used in agent based monitoring. The device(s) 136 do not include an agent and are monitored by the proxy client 131 using agentless monitoring (e.g., using WMI, SNMP). The device(s) 132 and 134 are monitored using agent based monitoring. Thus, in the network A 100A, each of the devices 132, 134, and 136 are monitored. In addition, the proxy client 131 may also provide monitoring for the device 130.

The network B 100B includes the device 140, the device(s) 142, the device(s) 144, the device(s) 146, and the device(s) 147. The proxy client 141 is installed on the device 140 and performs discovery and monitoring service for other devices in the network B 100B. As illustrated in FIG. 1, the proxy client 151 has discovered the device(s) 142, device(s) 144, device(s) 146, and device(s) 147.

The device(s) 142 each include a system agent 143 and each of the device(s) 144 includes an end user agent 145. The device(s) 146 do not include an agent and are monitored by the proxy client 131 using agentless monitoring (e.g., using WMI, SNMP). The device(s) 142 and 144 are monitored using agent based monitoring. The device(s) 147 are not monitored. The proxy client 141 may also provide monitoring for the device 140.

The network C 100C includes the device 150, the device 152, the device(s) 154, the device(s) 155, the device(s) 156, and the device(s) 157. The proxy client 151 is installed on the device 150 and performs discovery and monitoring service for the device(s) 156 and the device(s) 157. The proxy client 153 is installed on the device 152 and performs discovery and monitoring for the device(s) 154. The device(s) 157 each include a system agent 158. The device(s) 154, the device(s) 155, and the device(s) 156 each do not include an agent. The device(s) 155 are not monitored.

The SaaS server 110 includes the monitoring module 115, the management module 117, and the data store 112. The monitoring module 115 allows the customers to register for monitoring (e.g., acquiring a license for a number of devices to be monitored), establish monitoring definitions, and view the results of the monitoring. The management module 117 provides management and reporting functionality for the customers based on the monitored information. For example, the management module 117 provides software variance reporting, hardware variance reporting, software license management, and other various reports regarding the status of the devices (e.g., view a list of the devices that are down). The management module 117 also allows the customers to configure rules that indicate certain actions should be taken based on the monitored information. For example, a rule may indicate than an alert should be generated (e.g., an email message be sent to identified recipients, an event should be logged) if a hardware parameter of a device meets a certain threshold (e.g., CPU usage reaches 90%). The data store 112 stores information related to the agent based SaaS IT management service including customer information (e.g., customer location, customer authentication information, billing information), discovery information, monitored information, etc. The discovery information and the monitored information for the customer A 102 is stored in the data store 113 and the discovery information and the monitored information for the customer B 103 is stored in the data store 114.

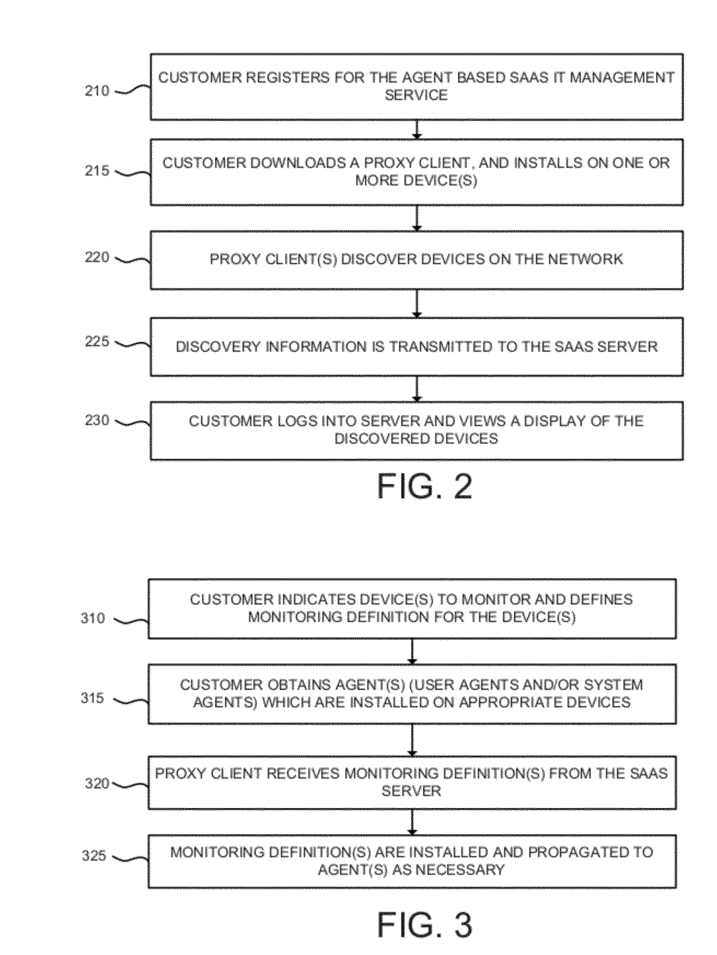

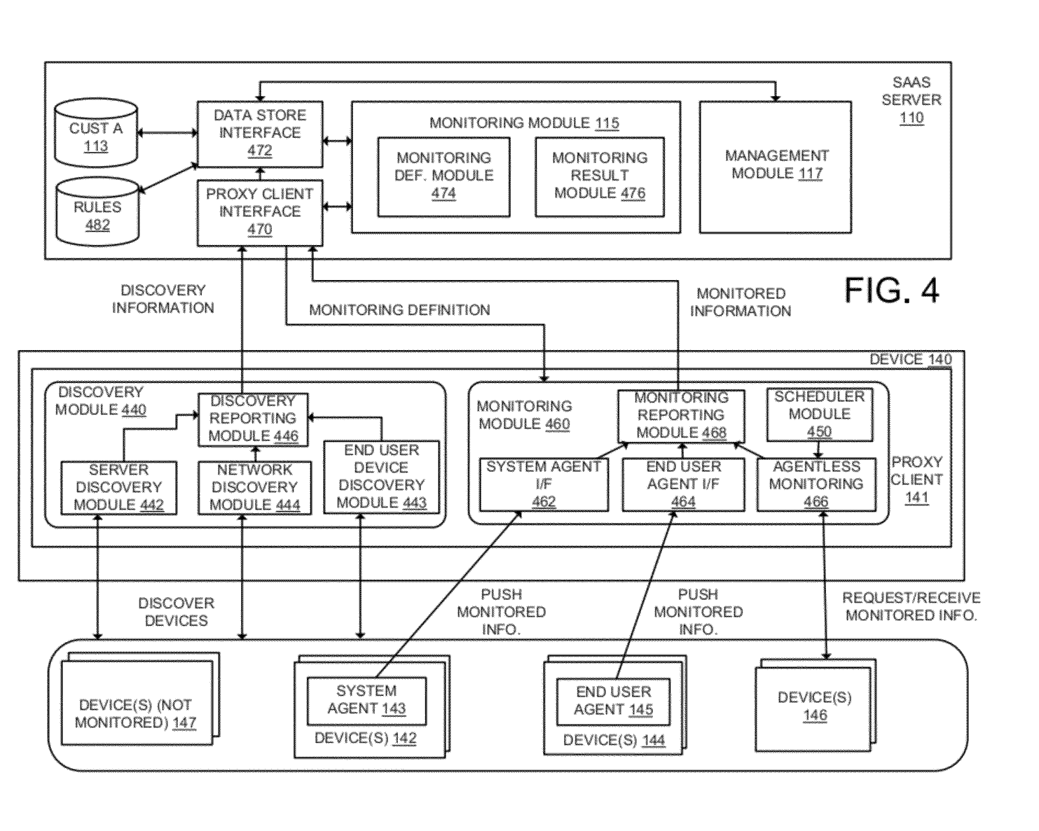

FIG. 2 is a flow diagram illustrating exemplary operations performed in the agent based SaaS IT service management system according to one embodiment. The operations of FIG. 2 will be described with reference to the exemplary embodiments of FIGS. 1 and 4. In particular, the operations of FIG. 2 will be described with reference to the customer A 102. However, it should be understood that the operations of FIG. 2 can be performed by embodiments of the invention other than those discussed with reference to FIGS. 1 and 4, and the embodiments discussed with reference to FIGS. 1 and 4 can perform operations different than those discussed with reference to FIG. 2.

At operation 210, the customer A 102 registers for the agent based SaaS IT service management. In one embodiment, registering includes acquiring a license for a number of devices to be monitored in the agent based SaaS IT management system. For example, assuming that the customer A 102 desires to have thirty devices monitored, the customer purchases a license to monitor those 30 devices. Registering may also include establishing an account including a username and a password for the customer A 102. In one embodiment, the customer A 102 accesses the server 110 to register for the service. In another embodiment, the customer registers for the service using a different device (e.g., a dedicated server for registration). In one embodiment, the customer A 102 creates a different username and password combination for the network A 100A and the network B 100B. Flow moves from operation 210 to operation 215.

At operation 215, the customer A 102 obtains one or more proxy clients and installs them on one or more devices. With respect to FIG. 1, the proxy client 141 is obtained and installed on the device 140 of the network B 100B. Typically, the device 140 is a server. In one embodiment, the customer A 102 downloads the proxy client 141 from the SaaS server 110. In another embodiment, the customer A 102 downloads the proxy client 141 from a different device. In another embodiment, the proxy client 141 is obtained using group policy, which will be described in greater detail later herein. It yet another embodiment, the proxy client 141 is pushed (e.g., by the SaaS server 110) to one or more devices of the customer A 102 (e.g., the device 130 and the device 140), which will be described in greater detail later herein. Of course the customer A 102 may obtain the proxy client using a combination of these embodiments. Flow moves from operation 215 to operation 220.

In one embodiment, as part of the installation, the customer A 102 configures the proxy client(s). Configuring the proxy client may include pointing the proxy client(s) to the SaaS server 110 (e.g., by providing an address of the server) and providing the proxy client(s) with authentication information such as the username and password of the customer A 102. For example, the customer A 102 configures the proxy client 131 to point to the SaaS server 110 and configures it with the username and password for the network A 100A, and similarly configures the proxy client 141 to point to the SaaS server 110 and configures it with the username and password for the network B 100B. The username and password combination may be the same for both the network A 100A and the network B 100B, or may be different. In another embodiment, the configuration information is preconfigured on behalf of the customer, for example by the SaaS server 110. As another example, the username and password combination of the customer A 102 and the address of the SaaS server 110 may be provided (e.g., in an XML file) along with the proxy client and the proxy client automatically configures itself according to the provided username and password of the customer A 102 and the address of the SaaS server 110. Configuring the proxy client may also include configuring the proxy client for discovery. For example, the beginning and ending range of a subnet to discover and the protocol to use for discovery may be configured. A username and password combination may also be configured depending on the type of protocol that is selected.

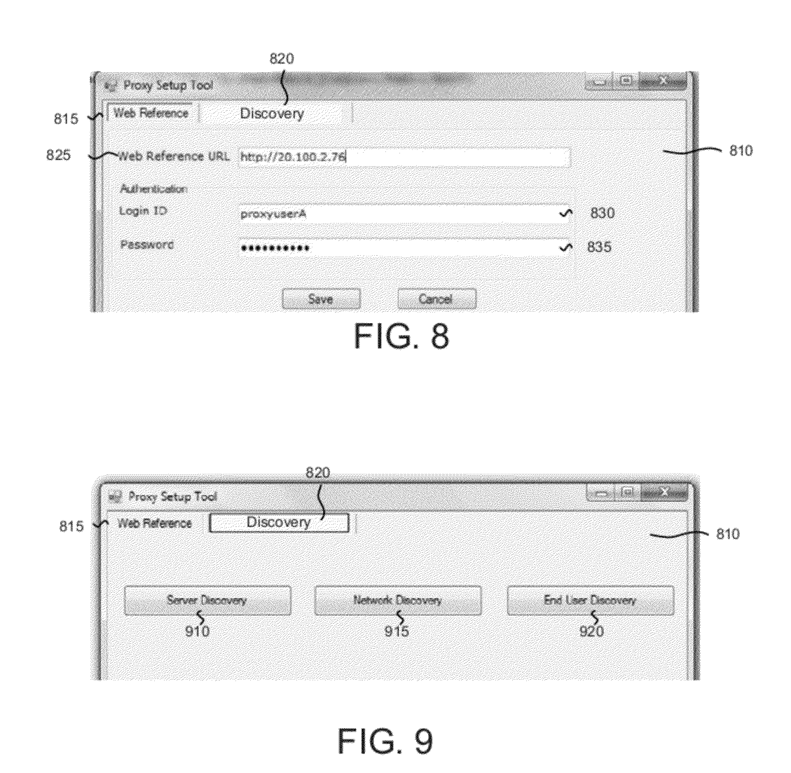

FIG. 8 illustrates an exemplary proxy client configuration tool 810 according to one embodiment. The proxy client configuration tool 810 is launched during installation of the proxy client and may also be launched any time thereafter. For purposes of explanation, the proxy client configuration tool 810 will be described with reference to the proxy client 141 installed on the device 140 of the network B 100B of the customer A 102. The proxy client configuration tool 810 includes a web reference tab 815 and a discovery tab 820. The web reference tab 815 allows customers to point the proxy client 141 to the SaaS server 110 using the web reference URL field 825 and provide authentication information using the login ID field 830 and the password field 835. In one embodiment, the authentication information is transmitted to the SaaS server 110 each time the proxy client 141 transmits data to the SaaS server 110 (e.g., when transmitting discovery information, monitoring information, etc.). As illustrated in FIG. 8, the web reference tab is selected and the customer has input information in the fields 825, 830, and 835.

Referring back to FIG. 2, at operation 220, the proxy client(s) discover network equipment devices in the network. For example, the proxy client(s) perform one or more of server discovery, network discovery, and end user device discovery. With reference to FIG. 4, which is a more detailed view of the proxy client 141 and its interaction with the SaaS server 110 and the devices in the network B 100B, the proxy client 141 includes the discovery module 440 that includes the server discovery module 442, the network discovery module 444, and the end user device discovery module 443. The discovery of the network equipment devices can use several techniques including passive discovery and active discovery. Passive discovery includes observing traffic (e.g., Ethernet traffic) while active discovery includes transmitting message(s) (e.g., ARP requests, ping messages, SNMP queries, WMI queries) to different addresses.

The server discovery module 442 discovers the servers within a specified subnet range and identifies characteristics of those servers (e.g., host name, serial number, IP address, server type, operating system type, vendor, customer, location, etc.). The network discovery module 444 discovers the network architecture (e.g., router(s), switch(es), access point(s), hub(s), etc.) within a specified subnet range. For example, it identifies all of the devices within the specified subnet range, the interfaces on each of those devices, the routing information of each of those devices, and connectivity between those devices. With the exception of the interfaces, network discovery does not identify information regarding the type of operating system, hardware installed (besides the interfaces), or software installed on those devices. The end user device discovery module 443 discovers the devices within a specified subnet range and identifies the type of device (e.g., server, laptop, desktop, etc.), vendor model, operating system, hardware configuration, and software configuration.

FIG. 9 illustrates the proxy client configuration tool 810 with the discovery tab 820 selected according to one embodiment. As illustrated in FIG. 9, the proxy client configuration tool 810 displays the server discovery button 910, the network discovery button 915, and the end user discovery button 920 when the discovery tab 820 is selected.

Selection of the server discovery button 910 causes the server discovery configuration screen 1010 to be displayed. The server discovery configuration screen 1010 allows the customer A 102 to input configuration information for the server discovery, including the subnet range 1015, the protocol type 1020 used for discovery (e.g., WMI, SNMP), a WMI user name in the field 1025, and SNMP community string(s) in the field 1030. Once configured, the customer A 102 can select the scan button 1035 to have the proxy client 141 begin the scan according to the configuration information.

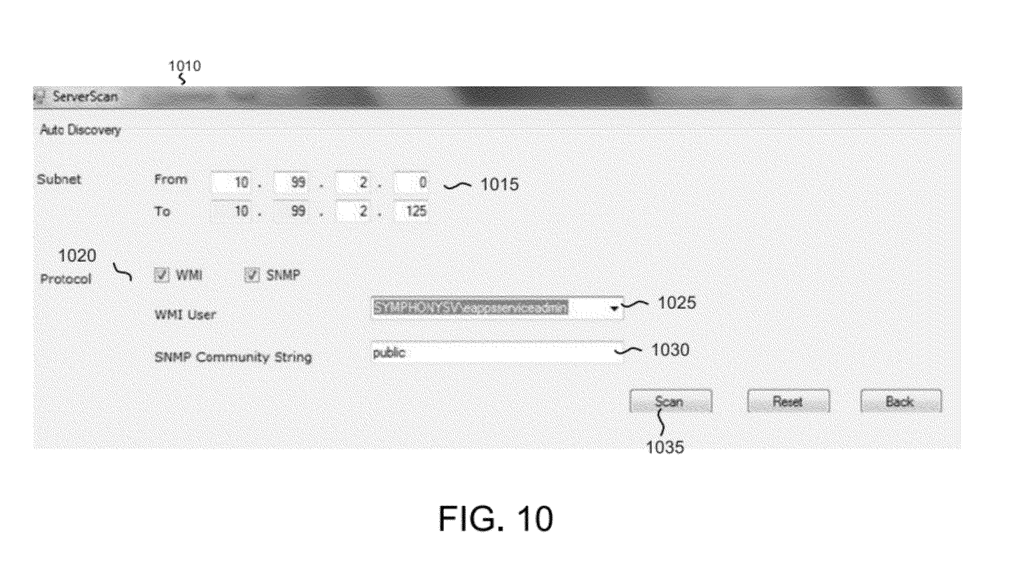

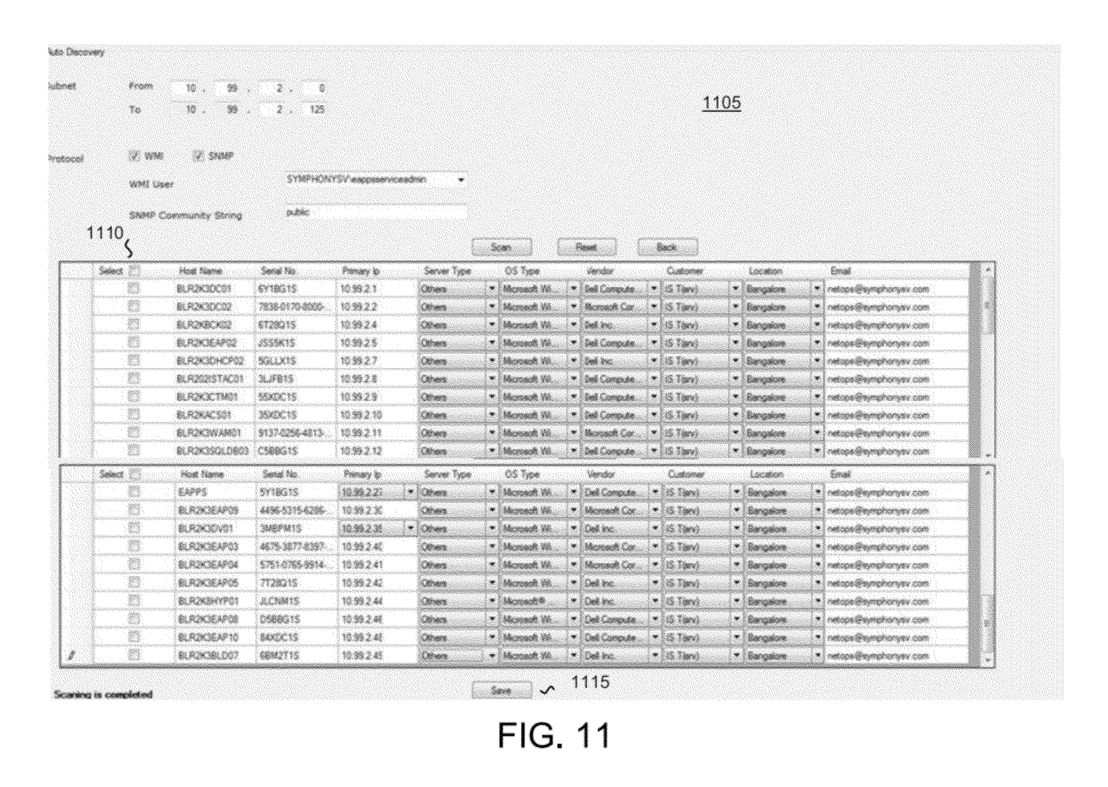

FIG. 11 illustrates an example server discovery result screen 1105 resulting from the server discovery performed according to the information configured in FIG. 10. The server discovery returns one or more parameters identifying the servers in the specified subnet according to one embodiment. As illustrated in FIG. 11, the parameters include: the host name for that server, the serial number for that server, the primary IP address assigned to that server, the type of that server, the operating system running on that server, the vendor of that server, the customer of that server, the location of that server, and an email address associated with that server. In one embodiment, some of the parameters are configured by the customer 110 (e.g., server type, operating system type, email address, customer, location). It should be understood that there may be more or less parameters returned in some embodiments.

The server discovery result screen 1105 also includes the selection field 1110 for each of the discovered servers that allows the customer A 102 to select those servers it wishes to report as discovered and/or be monitored to the SaaS server 110. After selecting one or more of the servers, the customer A 102 selects the save button 1115 to cause the proxy client 141 (e.g., the discovery reporting module 446) to generate one or more XML files that indicate the discovery information for the selected servers and transmits those XML file(s) along with the authentication information (username and password) to the SaaS server 110 using web services (e.g., HTTP or HTTPS). The XML file(s) may also be encrypted.

Referring back to FIG. 9, selection of the network discovery button 915 causes the network discovery configuration screen 1310 to be displayed. The network discovery configuration screen 1310 allows the customer A 102 to input configuration information for the network discovery, including the subnet range 1315 and one or more SNMP community strings in the field 1320. The network discovery configuration screen 1310 also allows the customer A 102 to exclude one or more IP addresses from the subnet range 1315. Once configured, the customer A 102 can select the submit button 1325 to cause the proxy client 141 to begin the network discovery according to the configured information.

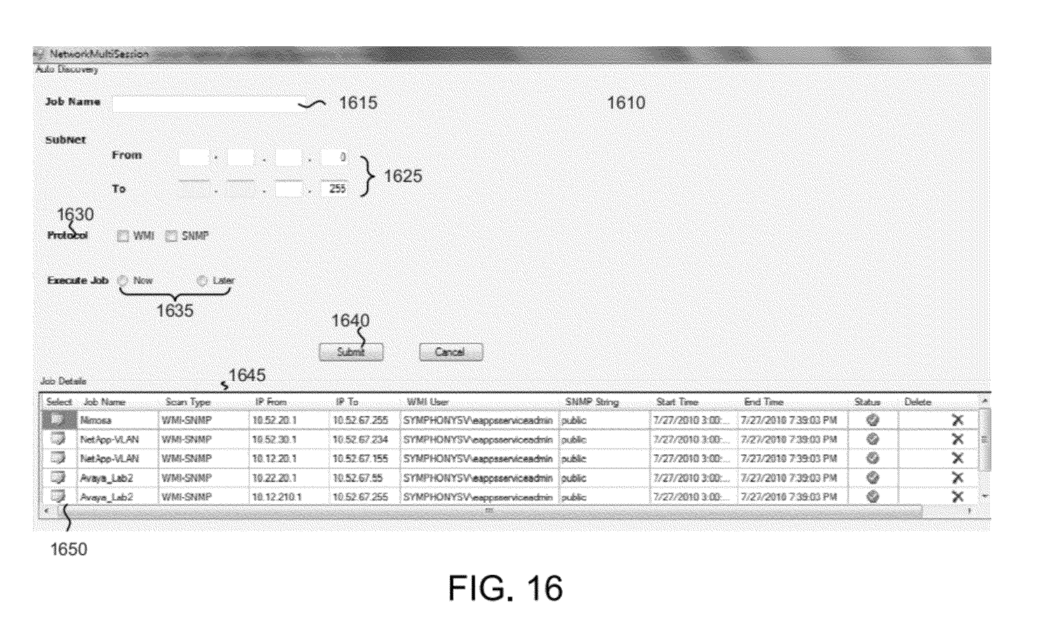

Referring back to FIG. 9, selection of the end user device discovery button 920 causes the end user device discovery screen 1610 to be displayed. The end user device discovery screen 1610 allows the customer A 102 to input configuration information for the end user device discovery and view results of completed end user device discovery jobs. For example, the job name field 1615 allows the customer A 102 to enter a name for the end user device discovery job. The customer A 102 can also input the subnet range using the subnet range fields 1625, and indicate the protocol type (e.g., WMI, SNMP) using the protocol type fields 1630. The customer A 102 can select whether to execute the discovery job at the current time or at a later time using the radio buttons 1635. In one embodiment, upon selection of the later radio button, the configuration screen 1610 displays a calendar to allow the user to select a date and time to run the job at a later time, which may also include an option to have the job run at a repeated interval (e.g., once a week, etc.). Once configured, the customer A 102 selects the submit button 1640 to cause the proxy client 141 to begin the end user device discovery according to the configured information. Although not illustrated in FIG. 16, a WMI user name field will be displayed to allow the customer A 102 to input a WMI user name when WMI is selected as the protocol type, and an SNMP community string field will be displayed to allow the customer A 102 to input SNMP community string(s) when the SNMP protocol is selected as the protocol type.

The end user device discovery screen 1610 also includes the end user device discovery job details 1645 which provides details regarding the end user device discovery jobs that have been run. The details include for each job the job name, the scan-type (e.g., protocol type), the IP address range, the WMI user name used, the SNMP community string(s), the start and ending time for the job, and an indication of the status of the job (e.g., whether it completed successfully, etc.). The job details 1645 also allows the customer to view specific details regarding the end user device discovery by selecting the specific details element 1650, which will, when selected, cause specific details including the type of device discovered (e.g., server, laptop, desktop, etc.), vendor and/or model, operating system, hardware configuration (e.g., processor type, RAM quantity and/or size, permanent storage (e.g., hard disk drive, solid state drive, etc.)) quantity and/or size, and software configuration to be transmitted (or at least an attempted transmission) to the SaaS server 110. In one embodiment, the proxy client 141 transmits, using web services (e.g., HTTP or HTTPS) end user device discovery information to the SaaS server 110 in the form of XML file(s) along with the authentication information of the customer A 102. The XML file(s) may also be encrypted.

Referring back to FIG. 2, flow moves from operation 220 to operation 225 and information about the discovered devices (discovery information) is transmitted to the SaaS server 110. For example, the proxy client 141 transmits discovery information that identify the device(s) 142, device(s) 144, device(s) 146 and device(s) 147 to the SaaS server 110. In one embodiment, the discovery information is included in one or more XML files that are sent to the SaaS server 110 using generic web services (e.g., using HTTP or HTTPS) and may be encrypted. The username and password of the customer A 102, which is used by the SaaS server 110 for authentication purposes and may be specific to a proxy client, may also be transmitted to the SaaS server 110 with the discovery information (it may be included in the same XML file(s) or may be transmitted separately). With respect to FIG. 4, the discovery reporting module 446 prepares the discovery information collected from the server discovery module 442, the end user device discovery module 443, and the network discovery module 444 and transmits it to the SaaS server 110. In one embodiment, if the SaaS server 110 cannot be reached (e.g., network connectivity is not up), then the proxy client caches the discovery information (e.g., the XML file(s)) and will transmit (or retransmit) the cached discovery information to the SaaS server 110 when the SaaS server 110 can be reached. Flow moves from operation 225 to operation 230.

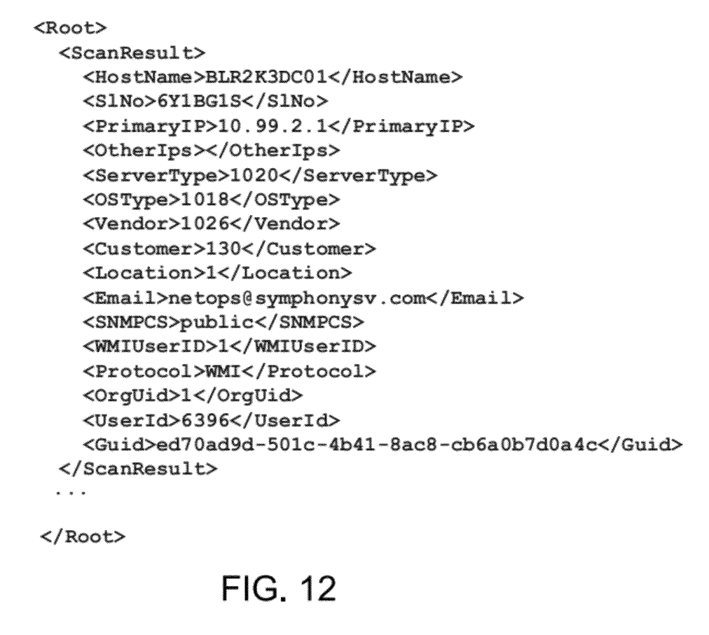

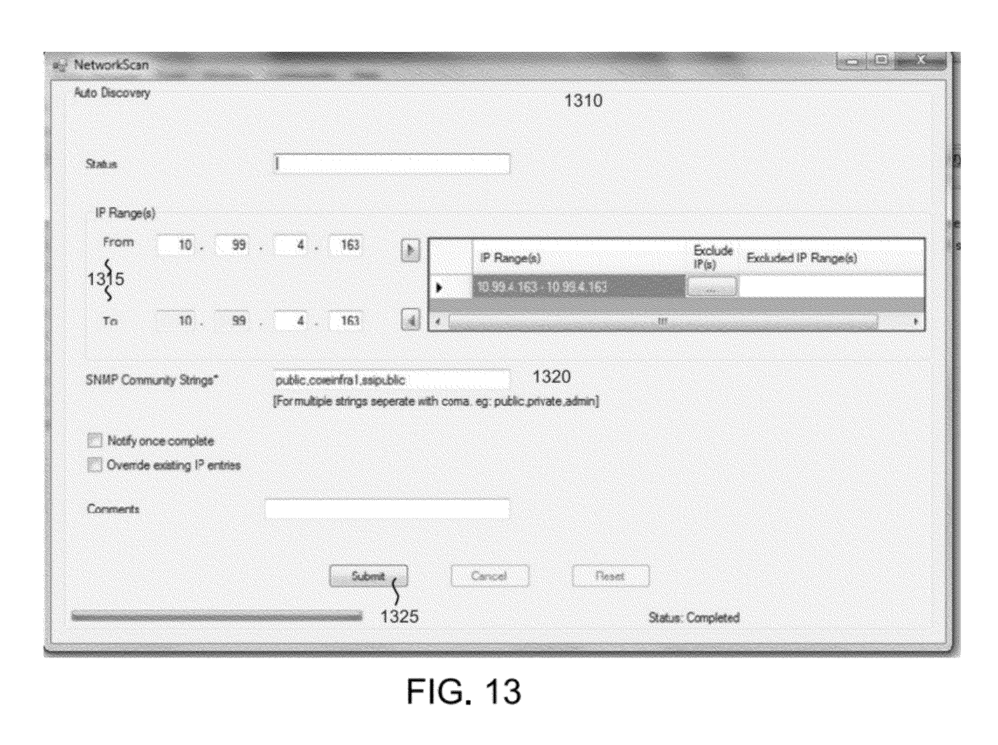

FIG. 12 illustrates an exemplary XML file containing server discovery information according to one embodiment. As illustrated in FIG. 12, the XML file includes parameters for the host name for the server, the serial number for that server, the primary IP address assigned to that server, other IP address(es) of that server (if existing), the type of that server, the operating system running on that server, the vendor of that server, the customer of that server, the location of that server, and an email address associated with that server. The XML file also indicates the protocol type used for discovery (e.g., WMI, SNMP). While FIG. 12 illustrates discovery information for a single server, it should be understood that discovery information for multiple servers may be included in a single XML file. For example, each different server may be represented with a different ScanResult tag.

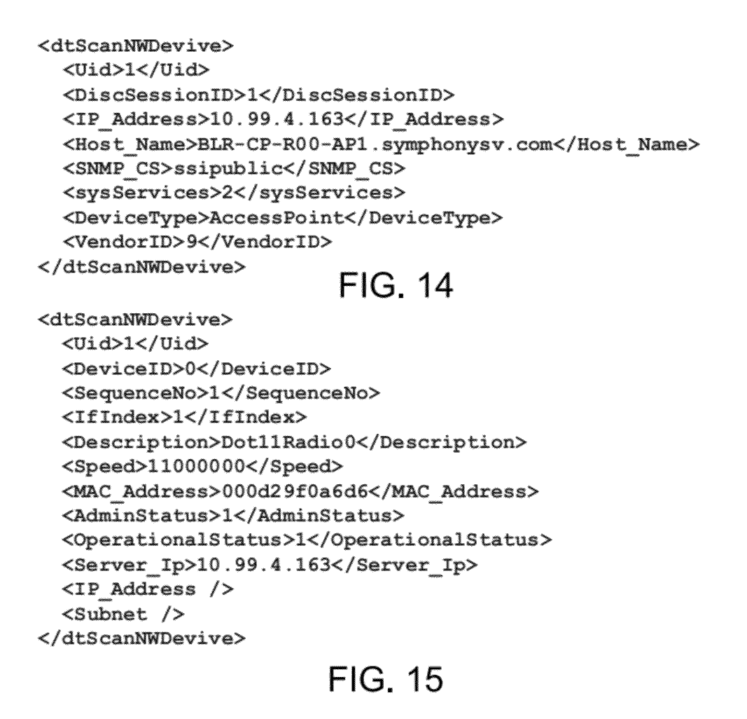

FIGS. 14 and 15 illustrate exemplary XML files containing network discovery information according to one embodiment. FIG. 14 illustrates information related to an access point that has been discovered in the network and FIG. 15 illustrates information related to the interface of that access point.

Sometime after the SaaS server 110 receives the discovery information and authenticates the customer, the SaaS server 110 installs the server discovery information in the data store 112. In one embodiment, the data store 112 includes databases that are private to customers. For example, as illustrated in FIG. 1, the data store 112 includes the database customer A 113, which stores information related to customer A's network (discovery information, monitoring information, etc.), and the database customer B 114, which stores information related to customer B's network. In one embodiment, prior to storing the discovery information, the SaaS server 110 authenticates the customer associated with that information. With reference to FIG. 4, the discovery reporting module 446 transmits the discovery information to the proxy client interface 470. The proxy client interface 470 authenticates the customer A 102 and then installs the discovery information into the data store 113 through the data store interface 472. In one embodiment, the data store interface 472 is an interface to a database management system (DMBS) that is used to manage the data store 112 (including the data stores 113 and 114).

In one embodiment, the customers can access their discovery information stored at the SaaS server 110. For example, after the discovery information for the customer network A is transmitted and stored at the SaaS server 110, the customer A can login to the SaaS server 110 and view the devices (associated with that customer) that have been discovered. Referring back to FIG. 2, flow moves from operation 225 to operation 230 and the customer logs into the server and views a display of the discovered devices. In one embodiment, the SaaS server 110 presents the discovery information in an integrated view that includes devices whose discovery information is reported by different proxy clients. For example, the SaaS server 110 formats the discovery information for devices discovered in the network A 100A and the network B 100B such that the customer A can view the results of the discovery in an integrated view. Of course, the customer A may also filter the results to display only certain devices discovered in certain networks and/or filter the results by other attributes (e.g., location, IP address range, operating system type, vendor, etc.).

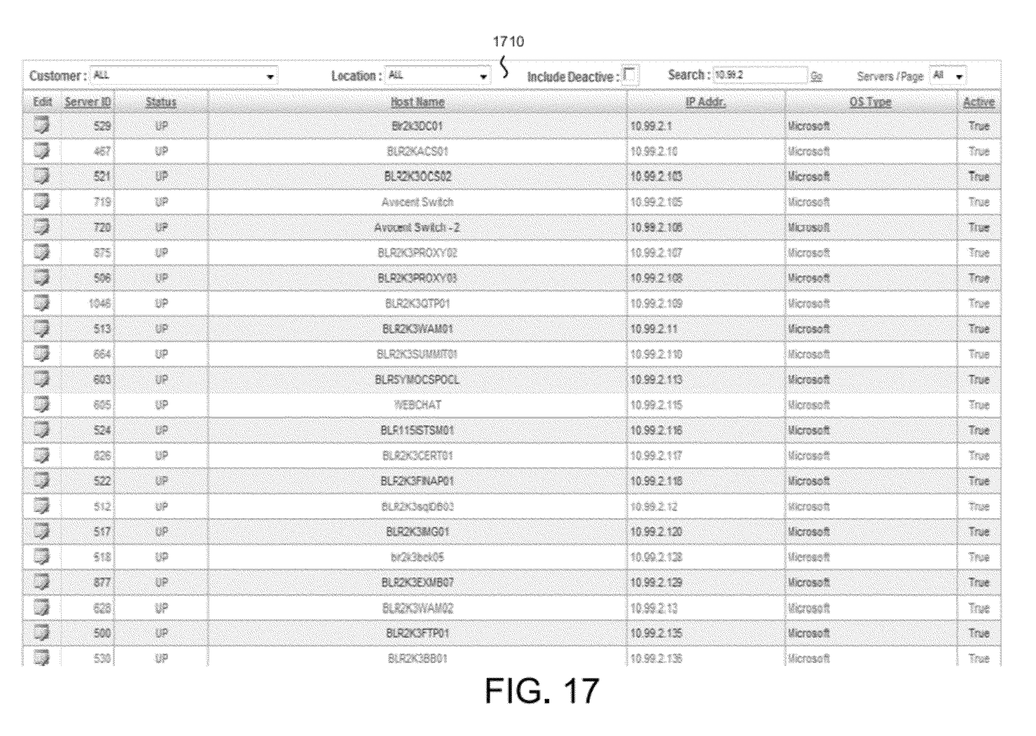

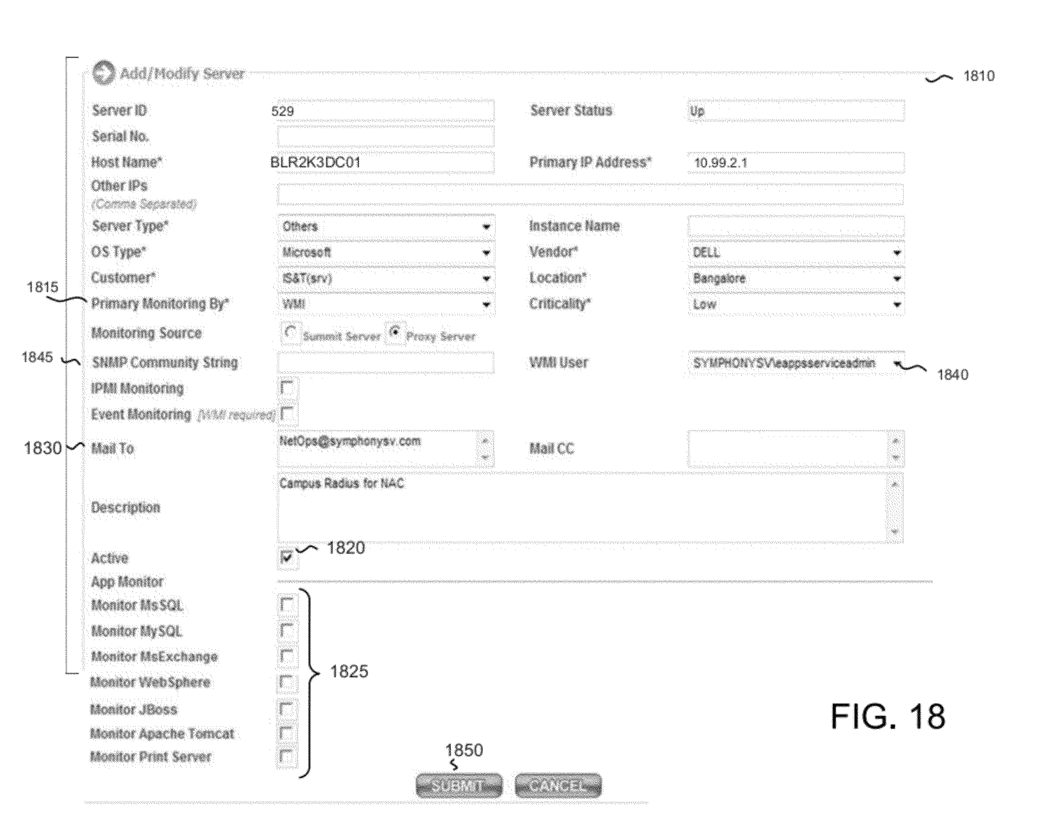

FIG. 17 illustrates one embodiment of an integrated discovery screen that shows devices that have discovered by multiple proxy clients according to one embodiment. The integrated discovery screen 1710 illustrated in FIG. 17 is in a table format, however it should be understood that this is exemplary as the integrated view may be visually presented to the customer in other ways (e.g., in a network map, graphical representation, etc.). The integrated discovery screen 1710 includes several different parameters for filtering and/or sorting the discovery information including by location, host name, IP address, operating system type, active or deactive, and status. In one embodiment, the integrated discovery screen 1710 also provides an option for the customer to select discovery information for a device to view further details that are not represented on the screen and/or also allow the customer to edit details of the of the discovery information (e.g., add or modify location, vendor, etc.).

In addition to discovery, the agent based SaaS IT service management service described herein also includes monitoring capability to monitor at least some of the discovered network devices. FIG. 3 is a flow diagram illustrating exemplary operations for establishing monitoring in the network according to one embodiment. The operations of FIG. 3 will be described with reference to the exemplary embodiments of FIGS. 1 and 4. In particular, the operations of FIG. 3 will be described with reference to the customer A 102. However, it should be understood that the operations of FIG. 3 can be performed by embodiments of the invention other than those discussed with reference to FIGS. 1 and 4, and the embodiments discussed with reference to FIGS. 1 and 4 can perform operations different than those discussed with reference to FIG. 3.

At operation 310, the customer A 102 indicates the device(s) to monitor and defines a monitoring definition for those device(s). For example, with reference to the devices in network B, the customer A 102 indicates that device(s) 142, device(s) 144, device(s) 146 will be monitored (the device(s) 147 are not monitored). In one embodiment, customers identify the device(s) to monitor using either the SaaS server 110 or through one or more proxy clients. For example, in one embodiment, after the devices are discovered and the discovery information is transmitted to the SaaS server 110, the customer A 102 can log into the SaaS server 110 to view a display of the discovered devices, which can be used by the customer when determining which devices to monitor. With respect to FIG. 4, the customer A 102 can log into the SaaS server 110 and use the monitoring definition module 474 of the monitoring module 115 to identify the device(s) to monitor and establish a monitoring definition. For example, the monitoring definition module 474 may present a view of the devices discovered (from the data stored in the data store 113) and allow the customer to select device(s) to be monitored and display monitoring definition configurations options to the customer.

FIG. 18 illustrates an exemplary monitoring configuration screen 1810 used to configure a monitoring definition for a device according to one embodiment. The monitoring configuration screen 1810 is displayed responsive to a customer selecting a device to monitor according to one embodiment. The monitoring configuration screen 1810 includes information identifying the device (e.g., server ID, IP address, location, server type, operating system type, customer, vendor, criticality), some of which may be populated from the discovery information stored in the data store and some of which can be input by the customer.

The monitoring configuration screen 1810 includes the primary monitoring by field 1815 which is used to set the monitoring type. Examples of the monitoring type include monitoring by a monitoring agent (e.g., end user agent or system agent) and agentless monitoring (e.g., SNMP, WMI, SSH, Telnet, availability monitoring only). As illustrated in FIG. 18, the customer has selected WMI as the monitoring type for the device. Depending on the type of monitoring selected, the customer may input other information. For example, if WMI is selected as the monitoring type, then the customer may indicate a WMI user name using the field 1840. As another example, if SNMP is selected as the monitoring type, then the customer may indicate an SNMP community string using the field 1845. In one embodiment, if agent based monitoring is selected as the monitoring type (e.g., end user agent or system agent), then the customer is prompted and/or a link is provided for the customer to obtain the agent.

The active field 1820 allows the customer to change the status of whether the device is being monitored (thus the customer may change whether the device is being monitored with the active field 1820). The monitoring application field(s) 1825 allow the customer to specify particular applications/services to monitor (e.g., SQL applications, email applications, word processing applications, etc.). The applications/services to monitor may depend on the type of monitoring selected. The mail to field 1830 allows the customer to input email address(es) that will receive reports about the device. For example, if the device fails, then an email may be sent to the email address indicating so. As another example, if hardware or software parameters meets a certain threshold (e.g., CPU usage hitting 90%), then an email may be sent to the email address indicating so. The threshold parameters may be specific to an application. For example, an email application may have different threshold parameters than an SQL database application.

The monitoring definition may also define when the monitoring is to occur (e.g., the monitoring interval). In one embodiment, a default monitoring interval is chosen based upon the monitoring type, which can be changed by the customer. Agentless monitoring may have a longer default monitoring interval than agent based monitoring.

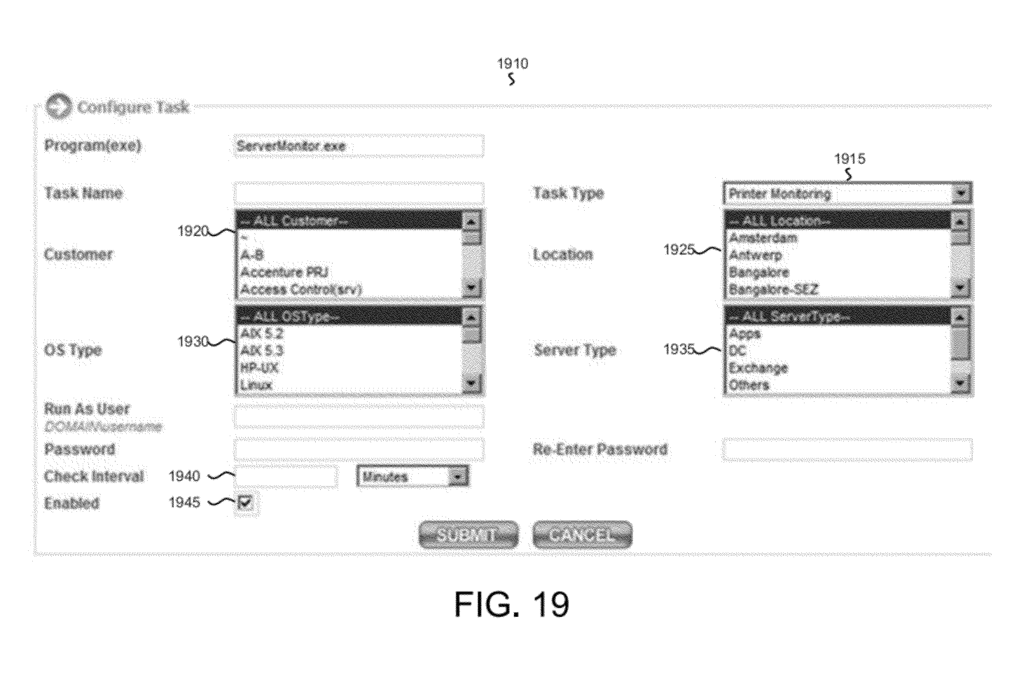

FIG. 19 illustrates an exemplary monitoring configuration scheduling screen 1910 that allows a customer to define the monitoring interval for monitoring tasks. The screen 1910 allows a customer to define a monitoring definition applicable for multiple devices that share common characteristics. For example, the customer may select a monitoring task from the monitoring task field 1915 that defines the parameters for monitoring. Examples of monitoring tasks include printer monitoring, services monitoring, HDD monitoring, hardware health monitoring, CPU monitoring, memory monitoring, and uptime monitoring. The monitoring tasks have default parameters and thresholds, which may be customizable by the customer. For example, the CPU monitoring task may include a threshold parameter of 85% which if reached, causes an alert for the customer to be generated. The customer can apply the monitoring tasks to only specific customers (if the customer has sub-customers) using the customer field 1920, specific location(s) using the location field 1925, specific operating system types using the OS type field 1930, and specific server types using the server type field 1935. The customer may also all input a username and password for the monitoring. In addition, the customer may configure the interval that the monitoring task is to be performed using the interval field 1940. The interval may be in seconds, minutes, days, etc. The customer may also use the enable field 1945 to enable or disable the task.

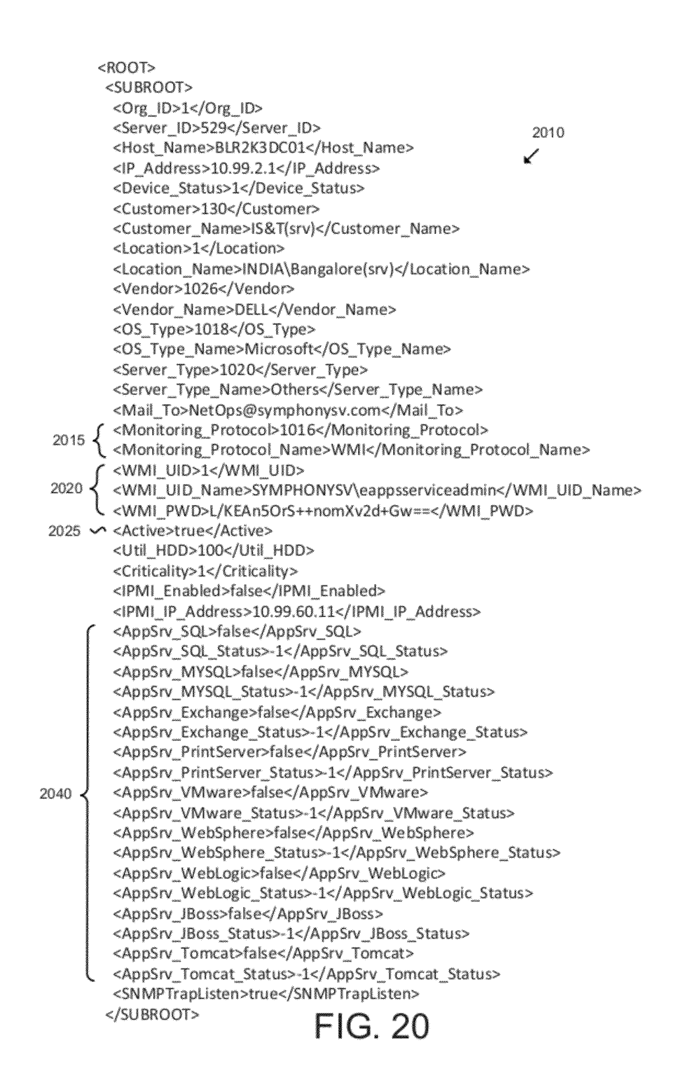

In one embodiment, the SaaS server generates an XML file that includes the monitoring definition configured by the customer (e.g., based on the information input in the monitoring configuration screen 1810 and/or screen 1910). FIG. 20 illustrates an exemplary XML file representing a monitoring definition according to one embodiment. The XML file 2010 includes information representing the monitoring definition configured in FIG. 18. As illustrated in FIG. 20, the XML file 2010 identifies the server (e.g., server ID, host name, IP address), provides the monitoring type 2015 (WMI is the monitoring type in this example), monitoring protocol authorization information 2020 (WMI user name and password in this example), indicates that monitoring is active 2025, and indicates whether certain applications 2040 are to be monitored (no applications are indicated as being monitored in this example). The XML file 2010 also includes other information including the location of the server, the customer, the vendor, etc. It should be understood that although the XML file 2010 includes a monitoring definition for only one server, a single XML file may include multiple monitoring definitions for multiple servers.

In one embodiment, the SaaS server 110 transmits the XML file(s) containing the monitoring definition(s) to the appropriate proxy client(s) once they are generated. In another embodiment, the proxy clients periodically query the SaaS server 110 for the monitoring definitions.

For purposes of explanation, the customer A 102 has configured monitoring to include both agentless monitoring (e.g., the proxy client 141 monitoring the device(s) 146) and agent based monitoring (e.g., the system agent 143 on a device 142). However, it should be understood that a customer may configure monitoring to include only agentless monitoring or agent based monitoring. Referring back to FIG. 3, flow moves from operation 310 to operation 315 where the customer A 102 obtains monitoring agent(s) (e.g., end user agent(s) and/or system agent(s)), which are installed on the appropriate devices.

In one embodiment, monitoring agents (system agents and end user agents) and a configuration file (which may be an XML file) that includes the monitoring definition and the address of a proxy client are pushed to devices through global policy management. For example, an OU (organizational unit) is used (or created if one does not exist) that includes the device(s) that are to receive the monitoring agent and configuration file (which may be part of a bundle) are defined as being part of the policy for that OU. The configuration file may be modified in order to change which proxy client the monitoring agent reports to.

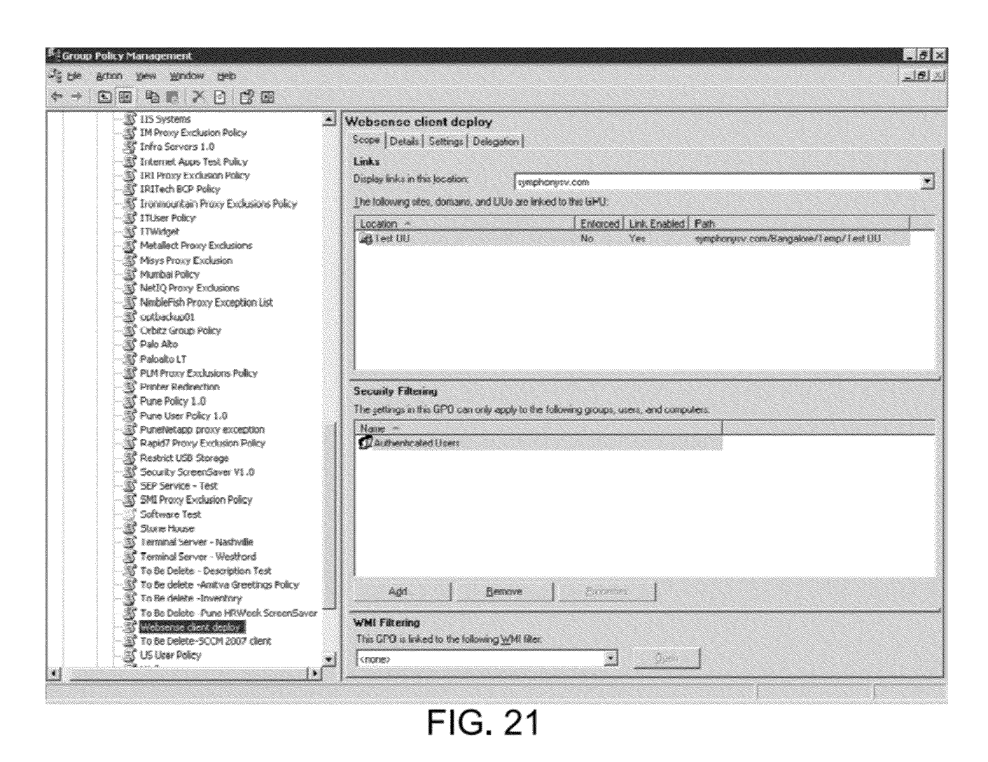

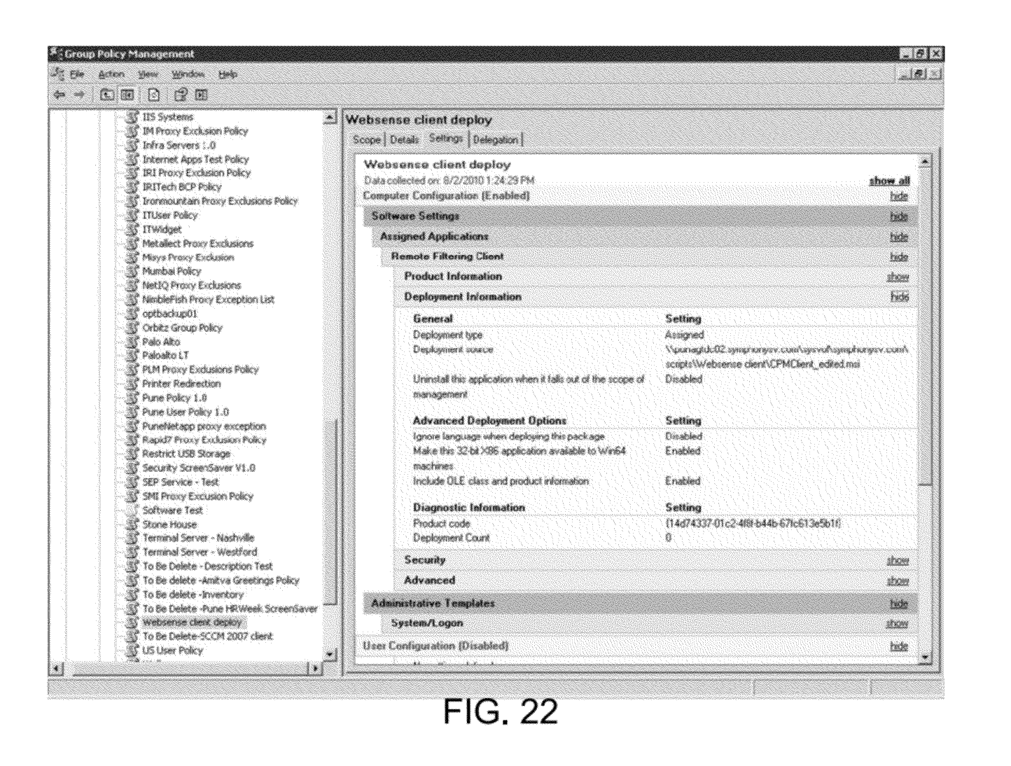

FIG. 21 illustrates a group policy management screen that illustrates an OU (called Test OU) has been established. FIG. 22 illustrates the group policy management screen that indicates that the deployment source, which is a network address (URL) to the source of the monitoring agent and configuration file, is assigned to the members of the OU. The next time that the device restarts, the monitoring agent will be installed and configured according to the configuration file. In a similar manner, the proxy client may also be installed using group policy management. In one embodiment, each monitoring agent (end user agent and system agent) checks for a new version each time it is started (e.g., from the SaaS server). If there is a new version, it will be downloaded an installed. In a similar way, the proxy clients periodically check for a new version and will download a new version when available (e.g., from the SaaS server).

Referring back to FIG. 3, flow moves from operation 315 to operation 320 and the proxy client receives one or more monitoring definitions from the SaaS server. For example, the proxy client 141 receives monitoring definition(s) from the SaaS server 110 regarding the device(s) 142, device(s) 144, device(s) 146 and the device 140 itself. In one embodiment, the proxy client 141 requests the monitoring definition(s) from the SaaS server 110 and provides authentication information (e.g., username and/or password) with the request. The SaaS server authenticates the proxy client 141 before providing the monitoring definition(s). In another embodiment, the monitoring definition(s) are pushed to the proxy client when they are created or updated without a specific request from that proxy client. As described above, the monitoring definitions may be included in an XML file and may be encrypted.

Flow moves from operation 320 to operation 325 and the monitoring module 460 installs the monitoring definition(s) applicable to the proxy client 141 and propagates those monitoring definitions(s) specific to monitoring agents (end user agents and/or system agents) as appropriate. The proxy client decrypts the monitoring definition(s) if they are encrypted.

In one embodiment, installing the monitoring definition(s) includes configuring a time based job scheduler (e.g., Cron, task scheduler) on the device for collecting data and/or transmitting the data to either the proxy client or the SaaS server. For example, with reference to FIG. 4, the proxy client 141 configures its agent-less monitoring module 466 to collect data from the device(s) 146 (e.g., using WMI, SNMP, etc.) at the configured monitoring interval using the scheduler module 450 (which is illustrated as being part of the monitoring module 460, but may be separate from the monitoring module 460). The device(s) 142 and device(s) 144 also configure their monitoring interval using a job scheduler.

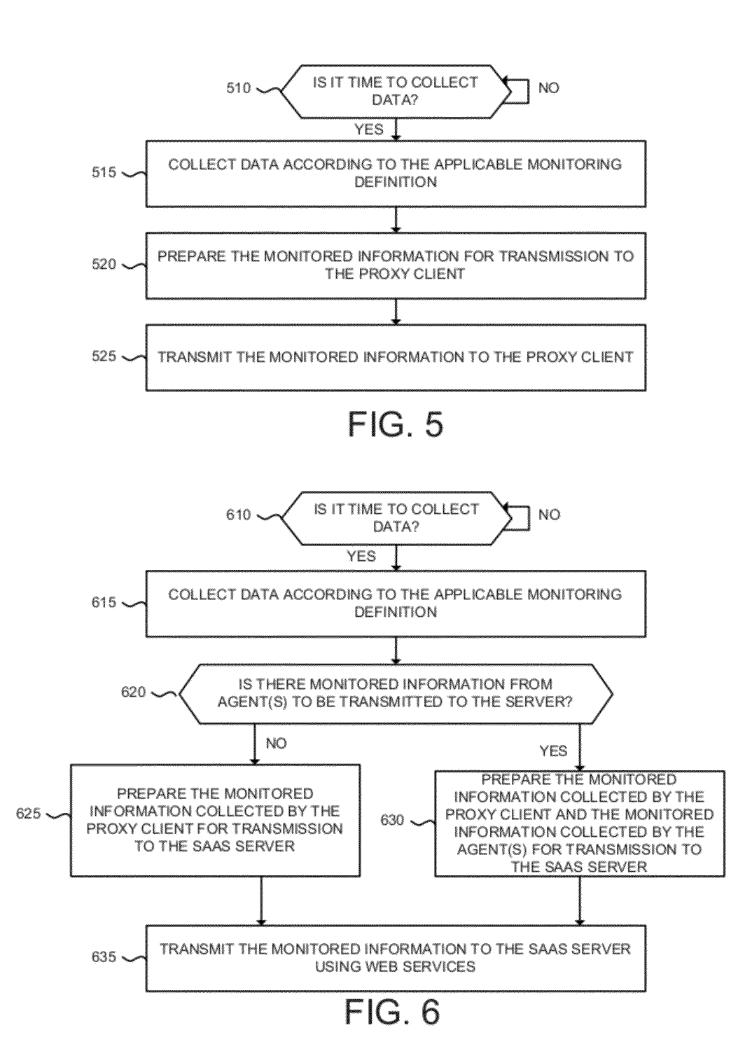

At the appropriate time for monitoring, the proxy client and/or the monitoring agents monitor the indicated device(s) as defined by the monitoring definition. FIG. 5 is a flow diagram that illustrates exemplary operations performed by a monitoring agent (a system agent or end user agent) for monitoring information. The operations of FIG. 5 will be described with reference to the exemplary embodiments of FIG. 4. However, it should be understood that the operations of FIG. 5 can be performed by embodiments of the invention other than those discussed with reference to FIG. 4, and the embodiments discussed with reference to FIG. 4 can perform operations different than those discussed with reference to FIG. 5.

At operation 510, the monitoring agent determines whether it is time to collect the data, which is determined by the monitoring interval configured on the monitoring agent. When it is time to collect data, then flow moves to operation 515 and the monitoring agent collects the data according to the applicable monitoring definition. For example, with reference to FIG. 4, the system agent 143 (installed on the device(s) 142) and the end user agent 145 (installed on the device(s) 144) collect data according to the monitoring definition installed for those devices. Flow then moves to operation 520 and the monitoring agent prepares the monitored information for transmission to the proxy client. In one embodiment, preparing the monitored information includes creating and populating an XML file that represents the monitored information, which may be encrypted.

Flow then moves to operation 525 and the monitored information is transmitted to the proxy client 141. For example, the system agent(s) 143 transmit the monitored information to the system agent interface 462 of the monitoring module 460 and the end user agent(s) 145 transmit the monitored information to the end user agent interface 464 of the monitoring module 460. If the connection between a monitoring agent and the proxy client fails or the monitored information otherwise cannot be successfully transmitted to the proxy client, in one embodiment the monitoring agent stores the monitored information and attempts to transmit the monitored information when the connection is restored.

FIG. 6 is a flow diagram that illustrates exemplary operations performed by a proxy client for monitoring and transmitting monitored information to the SaaS server according to one embodiment. The operations of FIG. 6 will be described with reference to the exemplary embodiments of FIG. 4. However, it should be understood that the operations of FIG. 6 can be performed by embodiments of the invention other than those discussed with reference to FIG. 4, and the embodiments discussed with reference to FIG. 4 can perform operations different than those discussed with reference to FIG. 6.

At operation 610, the proxy client 141 determines whether it is time to collect the data, which is determined by the monitoring interval configured the proxy client 141. When it is time to collect data, then flow moves to operation 615 and the proxy client 141 collects the data according to the applicable monitoring definition. For example, with reference to FIG. 4, the agentless monitoring module 466 collects data from the device(s) 146 (e.g., using WMI, SNMP, or other agentless monitoring techniques).

Flow then moves to operation 620 and the proxy client 141 determines whether there is monitored information received from monitoring agents (e.g., from the system agent(s) 143 and/or the end user agent(s) 145) that is to be transmitted to the SaaS server 110. If there is not, then flow moves to operation 625 and the proxy client 141 prepares the monitored information the proxy client 141 has collected for transmission to the SaaS server 110. In one embodiment, preparing the monitored information includes creating and populating an XML file that represents the monitored information, which may be encrypted.

If there is monitored information received from at least one monitoring agent that is to be transmitted to the SaaS server 110, then flow moves to operation 630 and the proxy client 141 prepares the monitored information that it has collected as well as the monitored information collected by the monitoring agent(s) for transmission to the SaaS server 110. For example, the proxy client 141 prepares the monitored information it has collected from the device(s) 146 using agentless monitoring and prepares the monitored information it has received from the system agent(s) 143 and the end user agent(s) 145. In one embodiment, preparing the monitored information includes creating and populating one or more XML files that represents the monitored information. The XML file(s) may be encrypted.

Flow moves from operation 625 and 630 to operation 635 and the proxy client 141 transmits the monitored information to the SaaS server 110 using generic web services (e.g., HTTP, HTTPs). If the connection between the proxy client 141 and the SaaS server 110 fails or the monitored information otherwise cannot be successfully transmitted to the SaaS server 110, in one embodiment the proxy client 141 stores the monitored information and attempts to transmit the monitored information when the connection is restored. In this way, the SaaS server 110 server is able to maintain monitored information on the discovered devices in the customer's private network without requiring a VPN link between the server and the network, without exposing SNMP and/or WMI protocols over the Internet, without requiring that each device in the network be connected or accessible by the SaaS server, and without additional configuration on firewalls of the customer's private network.

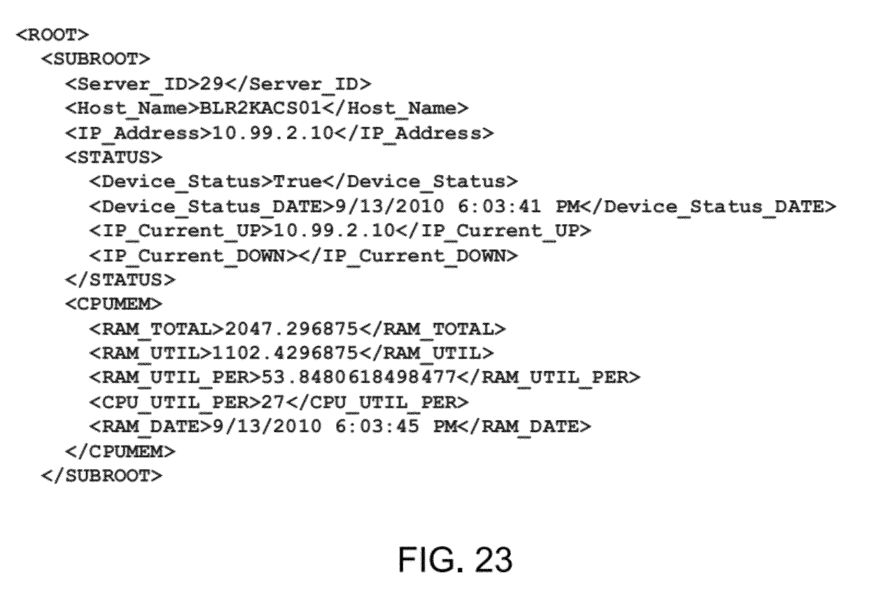

FIG. 23 illustrates an exemplary XML file containing monitored information according to one embodiment. As illustrated in FIG. 23, the XML file identifies the device that was monitored, includes status parameters (e.g., whether the device is up, the date and time of the information, the IP address(es) that are up) and includes specific hardware parameters (e.g., total RAM in the device, RAM utilization, RAM utilization percentage, CPU utilization, and the date and time that the information was collected). The information included in the exemplary XML file is for exemplary purposes as other XML files containing monitored information can include different and/or additional information. For example, if the monitored definition indicated monitoring for a specific application, the XML file containing the monitored information would have data that reflects monitoring for that specific application.

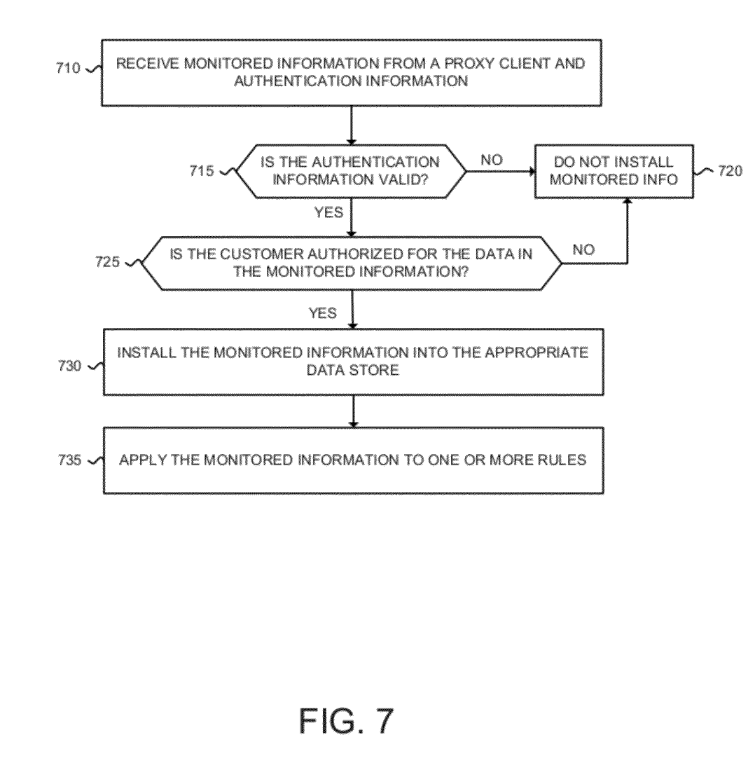

In one embodiment, the proxy client transmits authentication information (e.g., username and/or password) along with the monitored information to the SaaS server 110. FIG. 7 is a flow diagram illustrating exemplary operations performed on the SaaS server when receiving monitored information from a proxy client according to one embodiment. The operations of FIG. 7 will be described with reference to the exemplary embodiments of FIG. 4. However, it should be understood that the operations of FIG. 7 can be performed by embodiments of the invention other than those discussed with reference to FIG. 4, and the embodiments discussed with reference to FIG. 4 can perform operations different than those discussed with reference to FIG. 7.

At operation 710, the SaaS server 110 (e.g., the proxy client interface 470 of the SaaS server 110) receives monitored information and authentication information (e.g., a username and/or password) from the proxy client 141. Flow then moves to operation 715 and the SaaS server 110 determines whether the authentication information is valid. For example, the SaaS server 110 compares the received authentication information with the stored authentication information (e.g., stored in the data store 112). If the authentication information is not valid, then flow moves to operation 720 and the monitored information is not installed. A customer belonging to the proxy client 141 that sent the monitored information may also be notified (e.g., by email, text message, phone call) that authentication failed. If the authentication information is valid, then flow moves to operation 725.

At operation 725, the SaaS server 110 determines whether the customer that belongs to the proxy client 141 (customer A 102) is authorized for the data in the monitored information. In other words, whether the customer is allowed to send the monitored information that is being sent. In one embodiment, the SaaS server 110 compares at least some of the data in the monitored information with the stored discovery information. If the data does not match, then it is an indication that the data being transmitted is not the customer's information and therefore flow moves to operation 720 and the monitored information is not installed. If the monitored information does match the stored discovery information, then flow moves to operation 730 and the monitored information is stored. For example, the monitored information is stored in the data store 113.

Flow then moves to operation 735 and the SaaS server 110 applies the monitored information is to one or more rules. For example, the management module 117 applies the monitored information to the rules 482. The rules may indicate certain actions to take based on the monitored information. For example, a rule may indicate that an email message be sent to identified recipients if hardware or software parameters of a device meets a certain threshold (e.g., CPU usage reaching 90%, a device has failed). The rules can be configured and/or defined by the customers. In addition, some rules are predefined and may be applied and/or modified by the customers. If a rule is triggered, then the appropriate action for the rule is executed (e.g., an email is sent).

If a customer has multiple proxy clients installed on their network, in some circumstances it is possible that multiple proxy clients are monitoring at least some of the same devices and be transmitting similar monitored information to the SaaS server 110. In one embodiment, the SaaS server 110 installs the latest monitored information, while in another embodiment the SaaS server 110 installs the monitored information received first from a proxy client in a given monitoring interval.

After the monitored information is installed, the SaaS server 110 can present the information to the customers in various ways. For example, the monitoring result module 476 can format the monitored information in various was. In one embodiment, the SaaS server 110 presents the monitored information in an integrated view for a particular customer that includes the latest monitored information collected and/or aggregated by each of their proxy clients.

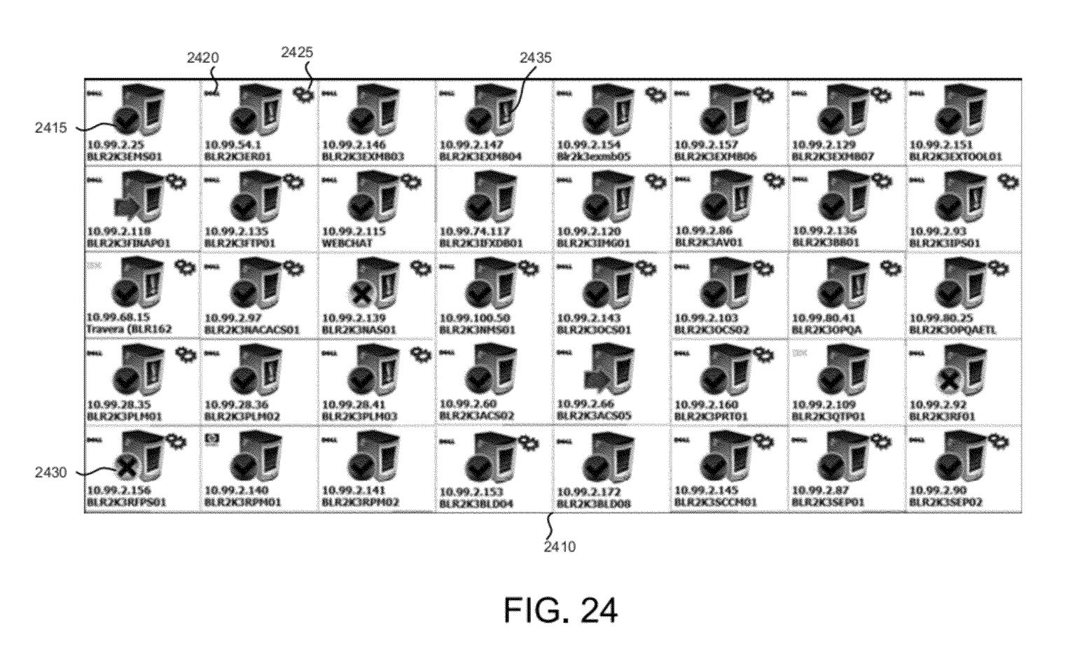

FIG. 24 illustrates an exemplary monitored information screen 2410 that shows devices, their status, and other monitoring information in a graphical way according to one embodiment. The monitored information screen 2410 includes several different icons that allows customers to quickly identify status and other parameters of their devices. For example, the icon 2415, which is illustrated as a checkmark, indicates that the device is up and running. The icon 2420 indicates the vendor of the device. The icon 2425, which is illustrated as gears, indicates that there are services that are being monitored on the device and that the monitored services are up and running. The icon 2430, which is illustrated as a large X, indicates that the device is currently down. Although not illustrated, in some embodiments there may be an icon (e.g., an X) over the icon 2425 that illustrates that some of the monitored services are currently down. The icon 2435, which is illustrated as an exclamation point on the device, indicates that at least some hardware or software (e.g., CPU, Memory, HDD) has exceeded a threshold. The monitored information screen 2410 also indicates the IP address assigned to the device and the host name assigned to the device.

It should be understood that these icons are exemplary and other icons may be used to represent similar or different information. For example, if the hardware health of a server is being monitored (e.g., raid controller, fan, temperature, voltage, etc.), there may be an icon that represents whether the hardware health parameters are in an acceptable range. As another example, there may be an icon that indicates if a device has a proxy client installed, an icon that indicates if a device has a system agent installed, and an icon that indicates if a device has an end user agent installed.

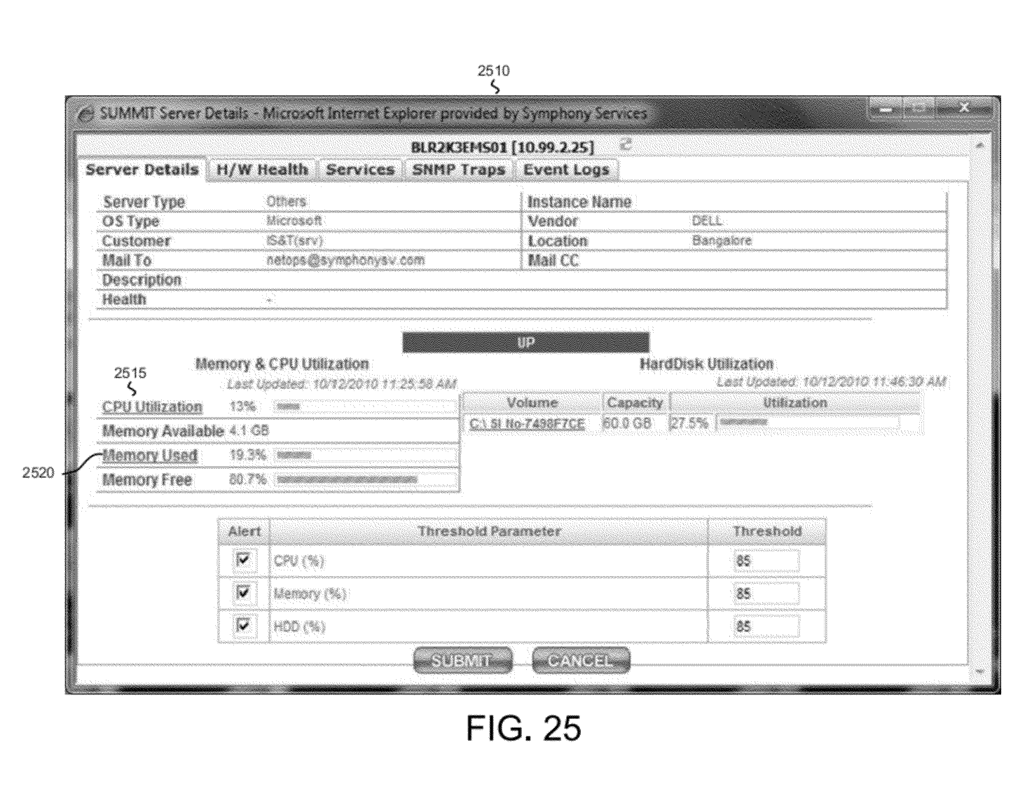

The monitored information screen 2410 also allows customers to select a device to view further monitored information about that device. FIG. 25 illustrates the monitored information details screen 2510 of a device that is being monitored, which may be displayed responsive to a customer selecting a device from the screen 2410. The device being monitored in the example of FIG. 25 is a server. The details screen 2510 includes multiple tabs for different monitoring types. The server details tab, which is illustrated in FIG. 25, includes details of the server including identifying information (e.g., server type, operating system type, customer, email address associated with the server, description, health, instance name, vendor, location) and utilization information (e.g., memory utilization, CPU utilization, HDD utilization). The server details tab also allows the customer to set alerts and the threshold parameter for CPU utilization, memory utilization, and HDD utilization.

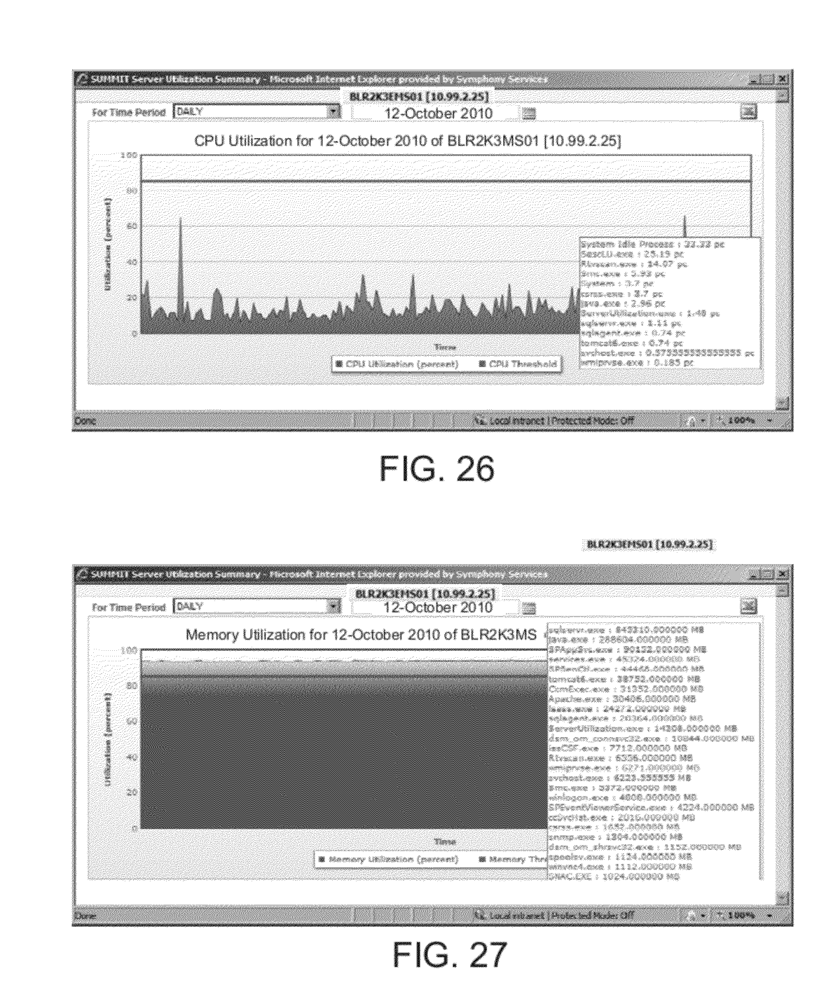

The CPU utilization link 2515 allows the customer to view further details regarding the CPU utilization. FIG. 26 illustrates an exemplary CPU utilization details screen that is displayed responsive to the customer selecting the CPU utilization link 2515 according to one embodiment. The memory utilization link 2520 allows the customer to view further details regarding the memory utilization. FIG. 27 illustrates an exemplary memory utilization details screen that is displayed response to the customer selecting the memory utilization link 2520 according to one embodiment.

The hardware health tab includes details regarding the health of the hardware of the server (e.g., battery, chassis intrusion, fan, hardware event log, memory, power supply, processor, temperature, voltage). The hardware health tab may also allow the customer to set alerts and threshold parameters for the different server health parameters. The services tab includes details regarding services being monitored of the server (if services are being monitored) that identify the name of the services and their status. The services tab may also allow the customer to set alerts regarding the services being monitored. The SNMP traps tab includes details regarding SNMP traps related to the server. The event logs tab includes details about events that have occurred on the server.

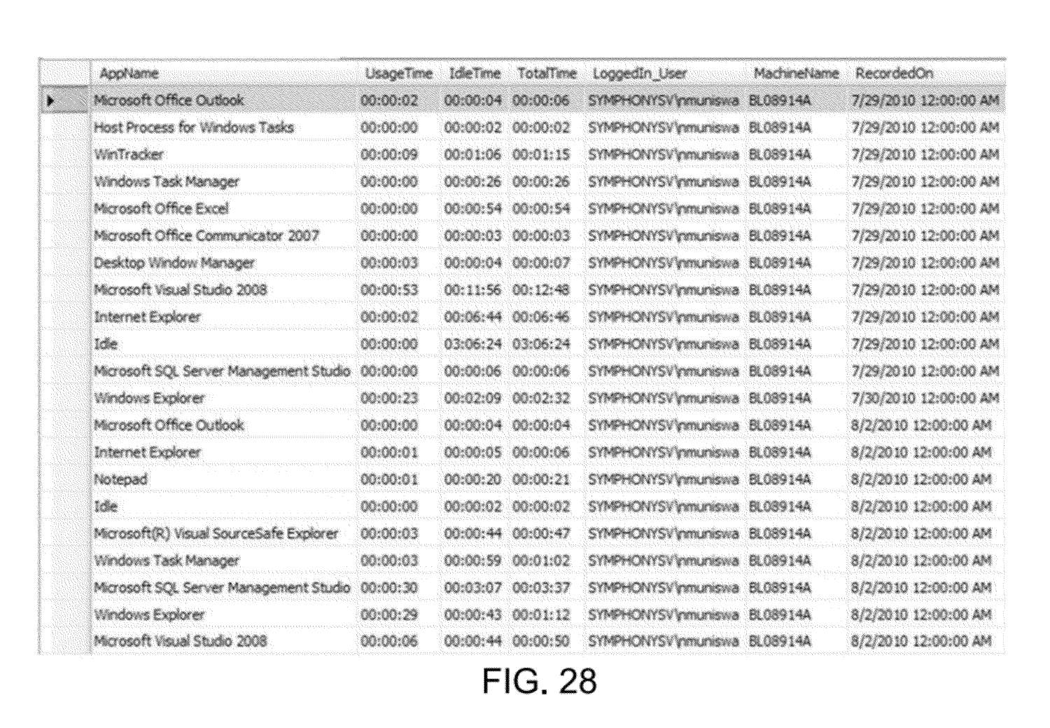

As previously described, monitoring agents (e.g., end user agents and system agents) may allow for more particularized information to be monitored than using agentless monitoring. FIG. 28 illustrates application usage data collected by a monitoring agent. As illustrated in FIG. 28, the actual usage time of the applications, the user using the applications is identified.

The customers may use the monitored information in various ways. One example is the use of the data in software license inventory and management. For example, the SaaS server allows the customer to enter in a number of licenses that it has for a particular software item. The SaaS server can compare the monitored information regarding the use of that software on the various devices in the customer's network with the number of licenses. In this way, the customer may determine whether the number of licenses is appropriate or whether the customer should adjust the number of licenses for that software item.

As another example, the SaaS server includes software variance reporting features using the monitored information. For example, the customer may define the software packages that are expected to be on a certain device and the SaaS server can compare the expected software packages with the software packages that are actually installed on the device using the monitored information. The customer may then generate a report of the variances using the SaaS server. As another example, the SaaS server includes hardware variance reporting features using the monitored information. For example, the customer may define the hardware attributes that are expected on a certain device (e.g., the size of memory, the number of memories, the HDD size, the number of HDDs) and the SaaS server can compare it with the hardware that is actually installed on the device using the monitored information.

The monitoring agents (end user agent or system agent) are configured to distinguish between a manual shutdown or manual hibernation of a device compared with an automatic hibernation or automatic shutdown of features of devices (e.g., powering off the hard drives, monitors, etc.), which can be proof that the devices are being shutdown in accordance with a power management and/or carbon credit monitoring program.

In some embodiments, redundant proxy clients may be employed such that if one of the proxy clients is down that affects monitoring (e.g., failure of the proxy client, failure or power-off of the device having the proxy client, etc.), other proxy client(s) take over the monitoring. In one embodiment, a customer has the ability to configure a proxy client (e.g., using the SaaS server or through the proxy client directly) as either being in primary mode or secondary mode. In primary mode, the proxy client has the primary responsibility of monitoring. In secondary mode, the proxy client will take over the role of the monitoring from its corresponding primary proxy client if the primary proxy client goes down. In some circumstances, a proxy client can operate in primary mode for certain devices in the network and simultaneously operate as a secondary proxy client for other devices in the network. In one embodiment, the secondary proxy clients check the status of their corresponding primary proxy clients through an exchange of periodic heartbeat messages (e.g., ping messages). In one embodiment, the discovery information and/or the monitored information is synchronized between a primary proxy client and its corresponding secondary proxy client(s).

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus for agent based monitoring software-as-a-service information technology service management, comprising:
a plurality of proxy clients installed on a first plurality of network equipment devices belonging to a customer, each of the proxy clients including:
one or more discovery modules to discover network equipment devices on at least one private network of the customer,
a discovery reporting module to transmit information identifying the devices discovered by the one or more discovery modules to a server using web services, and
a monitoring module to perform the following:
monitor a set of one or more network equipment devices according to one or more monitoring definitions configured by the customer to collect information of that set of network equipment devices, wherein each of the one or more monitoring definitions identifies which of the set of network equipment devices to monitor and defines one or more parameters of the monitoring, and wherein the monitored set of network equipment devices have been discovered by the one or more discovery modules and are apart from the first plurality of network equipment devices,
receive monitored information from a plurality of monitoring agents installed on a second plurality of network equipment devices, wherein the second plurality of network equipment devices have been discovered by the one or more discovery modules and are apart from the first plurality of network equipment devices, and wherein the monitored information received from the plurality of monitoring agents is at least partially different than the information collected from the set of network equipment devices,
transmit the information collected from the set of network equipment devices and the received monitored information to the server using web services.

2. The apparatus of claim 1, wherein the proxy client is to transmit the information collected from the set of network equipment devices and the received monitored information in an XML (Extensible Markup Language) file.

3. The apparatus of claim 1, further comprising:
the server, coupled with each of the proxy clients over a public network, the server including:
a proxy client interface to receive the information transmitted from each of the proxy clients and cause that information to be stored in a data store, and
a monitoring module to provide the customer with the ability to establish the one or more monitoring definitions and display the transmitted information from each of the proxy clients.

4. The apparatus of claim 3, wherein each proxy client is to transmit authentication information to the server along with the information collected from the set of network equipment devices and the received monitored information from the plurality of monitoring agents, and wherein the proxy client interface of the server is further to authenticate each proxy client based on the authentication information and authorize the customer based on the information received from that proxy client prior to causing the information transmitted from that proxy client from being stored in the data store.

5. The apparatus of claim 3, wherein the monitoring module is to present the transmitted information from each of the proxy clients of the customer in a graphical and integrated view.

6. The apparatus of claim 3, wherein the server further includes a management module to generate a plurality of reports from the information stored in the data store.

7. A method performed in a proxy client of an agent based monitoring software-as-a-service information technology service management system, wherein the proxy client is installed on one of a plurality of network equipment devices belonging to a customer, the method comprising:
discovering a plurality of network equipment devices of at least one private network of the customer;
transmitting information identifying the discovered devices to a server using web services, wherein the server is not owned or operated by the customer;
monitoring a set of one or more discovered network equipment devices according to one or more monitoring definitions configured by the customer to collect information of that set of network equipment devices, wherein each of the one or more monitoring definitions identifies which of the set of network equipment devices to monitor and defines one or more parameters of the monitoring;
receiving monitored information from a plurality of monitoring agents installed on a plurality of discovered network equipment devices, wherein the monitored information received from the plurality of monitoring agents is at least partially different than the information collected from the set of network equipment devices; and
transmitting the information collected from the set of network equipment devices and the received monitored information to the server using web services.

8. The method of claim 7, wherein the monitoring is performed with a protocol selected from the group consisting of WMI (Windows Management Instrumentation) and SNMP (Simple Network Management Protocol).

9. The method of claim 7, wherein the information collected from the set of network equipment devices and the received monitored information are transmitted in an XML (Extensible Markup Language) file.

10. The method of claim 9, further comprising transmitting authentication information to the server along with the XML file to allow the server to authenticate the proxy client.

11. The method of claim 7, wherein the monitoring is performed periodically according to an interval configured in the one or more monitoring definitions.

12. The method of claim 11, further comprising storing the information collected from the set of network equipment devices and the received monitoring information until confirmation that the server has received the same or until a more recent version of information collected from the set of network equipment devices and monitored information is received from the plurality of monitoring agents.

13. A non-transitory machine-readable storage medium that provides instructions that, when executed by a processor, causes said processor to perform operations comprising:
discovering a plurality of network equipment devices of at least one private network of a customer;
transmitting information identifying the discovered devices to a server using web services, wherein the server is not owned or operated by the customer;
monitoring a set of one or more discovered network equipment devices according to one or more monitoring definitions configured by the customer to collect information of that set of network equipment devices, wherein each of the one or more monitoring definitions identifies which of the set of network equipment devices to monitor and defines one or more parameters of the monitoring;
receiving monitored information from a plurality of monitoring agents installed on a plurality of discovered network equipment devices, wherein the monitored information received from the plurality of monitoring agents is at least partially different than the information collected from the set of network equipment devices; and
transmitting the information collected from the set of network equipment devices and the received monitored information to the server using web services.

14. The non-transitory machine-readable storage medium of claim 13, wherein the monitoring is performed with a protocol selected from the group consisting of WMI (Windows Management Instrumentation) and SNMP (Simple Network Management Protocol).

15. The non-transitory machine-readable storage medium of claim 13, wherein the information collected from the set of network equipment devices and the received monitored information are transmitted in an XML (Extensible Markup Language) file.

16. The non-transitory machine-readable storage medium of claim 15, further comprising transmitting authentication information to the server along with the XML file to allow the server to perform authentication.

17. The non-transitory machine-readable storage medium of claim 13, wherein the monitoring is performed periodically according to an interval configured in the one or more monitoring definitions.

18. The non-transitory machine-readable storage medium of claim 17, further comprising storing the information collected from the set of network equipment devices and the received monitoring information until confirmation that the server has received the same or until a more recent version of information collected from the set of network equipment devices and monitored information is received from the plurality of monitoring agents.
